(19) United States
(12) Patent Application Publication
(10) Pub. No.: US 2024/0343750 A1
(43) Pub. Date: Oct. 17, 2024

(54) Metallocene Catalyst Compounds for Producing Polyolefins

(71) Applicant: ExxonMobil Technology and Engineering Company, Baytown, TX (US)

(72) Inventors: Alexander Z. Voskoboynikov, Moscow (RU); Mikhail I. Sharikov, Moscow (RU); Pavel S. Kulyabin, Moscow (RU); Dmitry V. Uborsky, Moscow (RU); Nikola S. Lambic, Houston, TX (US); Jo Ann M. Canich, Houston, TX (US)

(21) Appl. No.: 18/596,477

(22) Filed: Mar. 5, 2024

Related U.S. Application Data
(60) Provisional application No. 63/488,680, filed on Mar. 6, 2023.

(51) Int. Cl. C07F 17/00; C08F 10/02; C08F 10/04; C08F 10/06; C08F 10/14

(52) U.S. Cl. CPC C07F 17/00; C08F 10/02; C08F 10/04; C08F 10/06; C08F 10/14

(57) ABSTRACT

The present disclosure relates to ansa-metallocene catalyst compounds, catalyst systems comprising such compounds, and uses thereof. In some embodiments, a catalyst compound is represented by Formula (I):

T_{y}LAMXₙ₋₂ (I),

wherein: M is a group 3-6 metal; n is the oxidation state of M; A is a monocyclic or polycyclic arenyl ligand bonded to M and is substituted by at least one phenanthridin-5-yl substituent; L is a monocyclic or polycyclic arenyl ligand bonded to M; T is a bridging group; y is 1 or 0; and each X is independently a univalent anionic ligand, or two Xs are joined and bound to M to form a metallocycle ring, or two Xs are joined to form a chelating ligand, a diene ligand, or an alkylidene ligand.

### CROSS REFERENCE TO RELATED APPLICATIONS

This application claims the benefit of and priority to U.S. Provisional Application No. 63/488,680 filed Mar. 6, 2023, the disclosure of which is incorporated herein by reference.

### FIELD OF THE INVENTION

The present disclosure relates to ansa-metallocene catalyst compounds, catalyst systems comprising such compounds, and uses thereof.

### BACKGROUND OF THE INVENTION

Polyolefins are widely used commercially because of their robust physical properties. For example, various types of polyethylenes, including high density, low density, and linear low density polyethylenes, are some of the most commercially useful. Polyolefins are typically prepared with a catalyst that polymerizes olefin monomers.

Catalysts for olefin polymerization typically have transition metals. For example, some catalysts are ansa-metallocenes (also referred to as “bridged” metallocenes), which can be activated by alumoxane or an activator containing a non-coordinating anion. Using these catalysts and catalyst systems, polymerization conditions can be adjusted to provide polyolefins having desired properties. There is interest in finding new metallocene catalysts and catalyst systems that provide polymers having specific properties, including useful molecular weights, high activity, and good processability.

In particular, polypropylene, such as isotactic polypropylene (iPP), is a desired polymer that has a large variety of uses. Isotactic polypropylene should have good processability but high molecular weight to provide polymer products (such as films) having toughness and a low amount of haze. However, discovering catalysts that are capable of forming such isotactic polypropylenes has been challenging. Further, even if desired polymer properties could be obtained, conventional catalysts used for forming isotactic polypropylene have low activity.

Regarding the polymer itself, in producing blown films, polymers with good processability are desired to achieve commercial throughput rates, while maintaining sufficient melt strength, such as bubble stability. Further, good physical properties (e.g., stiffness, roughness, or tear strength) for the final film product are desirable. Based on the balance of properties, certain high melt strength polypropylenes can be good candidates for blown film applications. It is observed that a polymer having a broad molecular weight distribution (Mw/Mn, or “MWD”) of such high melt strength polypropylenes provides shear thinning, and the presence of a high molecular weight tail (as shown by Gel Permeation Chromatography (GPC)) provides sufficient melt strength and high stiffness for such films. However, it has been found that during the film blowing process, some polypropylenes having a high molecular weight tail, while having good melt strength and shear thinning, exhibit low gloss and high haze, therefore appearing unclear.

There is a need for new catalysts and catalyst systems capable of producing isotactic polypropylenes at high activity with the isotactic polypropylene having a high molecular weight, useful processability, and capable of forming low haze products such as films.

### SUMMARY OF THE INVENTION

The present disclosure relates to ansa-metallocene catalyst compounds, catalyst systems comprising such compounds, and uses thereof.

In some embodiments, a catalyst compound is represented by Formula (I):

T_{y}LAMXₙ₋₂ (I),

wherein: M is a group 3-6 metal; n is the oxidation state of M; A is a substituted monocyclic or polycyclic arenyl ligand bonded to M and is substituted by at least one phenanthridin-5-yl substituent; L is a substituted or unsubstituted monocyclic or polycyclic arenyl ligand bonded to M, and optionally, may be the same as A; T is a bridging group; y is 1 or 0; and each X is independently a univalent anionic ligand, or two Xs are joined and bound to M to form a metallocycle ring, or two Xs are joined to form a chelating ligand, a diene ligand, or an alkylidene ligand.

In some embodiments, a catalyst compound is represented by Formula (III):

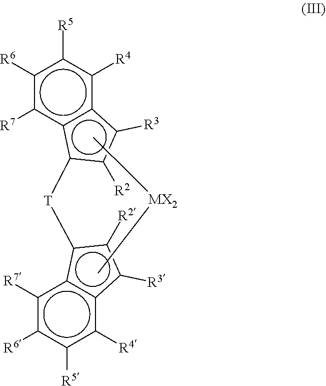

wherein: M is Zr or Hf; each of R², R³, R⁵, R⁶, R⁷, R^{2′}, R^{3′}, R^{5′}, R^{6′,} and R^{7′} is independently selected from the group consisting of hydrogen, a hydrocarbyl, a heteroatom, and a heteroatom-containing group, or one or more of R² and R³, R⁵ and R⁶, R⁶ and R⁷, R^{2′} and R^{3′}, R^{5′} and R⁶, and R⁶ and R^{7′} are joined to form one or more saturated, partially saturated, or aromatic rings; T is represented by the formula R⁸₂J or (R⁸)₄J₂ wherein J is selected from the group consisting of C, Si, and Ge, wherein each instance of R⁸ is independently selected from the group consisting of hydrogen, halide, and a C₁ to C₄₀ hydrocarbyl, or two instances of R⁸ are joined to form a cyclic structure including a saturated ring system, a partially saturated ring system, an aromatic ring system, or a fused ring system; each X is independently selected from the group consisting of a halide, a hydrocarbyl, a hydride, an amide, an alkoxide, a sulfide, and a phosphide, or two instances of X are joined together to form a metallocycle ring, or two instances of X are joined to form a chelating ligand, a diene ligand, or an alkylidene; and each of R⁴ and R^{4′} is independently represented by Formula (IIIa):

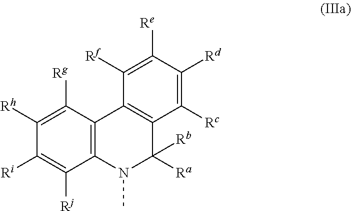

wherein each instance of R^{a}, R^{b}, R^{c}, R^{d}, R^{e}, R^{f}, R^{g}, R^{h}, Rⁱ, and R^{j} is independently selected from the group consisting of hydrogen, hydrocarbyl, a heteroatom, and a heteroatom-containing group, or any adjacent R^{e}, R^{d}, R^{c}, R^{f}, R^{g}, R^{h}, Rⁱ, and Rⱼ is joined to form one or more hydrocarbyl rings or heterocyclic rings each having 5, 6, 7, or 8 ring atoms, wherein the dashed line indicates the bond to a 4-position of an indenyl ligand shown in Formula (III).

In yet another aspect, embodiments of the present disclosure provide a catalyst system comprising an activator and a catalyst compound of the present disclosure.

In still another aspect, embodiments of the present disclosure provide a polymerization process comprising a) contacting one or more olefin monomers with a catalyst system comprising: i) an activator and ii) a catalyst compound of the present disclosure.

### DEFINITIONS

For the purposes of this disclosure and the claims herein, the definitions and conventions below shall apply.

For the purposes of the present disclosure, the numbering scheme for the Periodic Table Groups is used as described in Chemical and Engineering News, v.63(5), pg. 27 (1985).

The following abbreviations may be used herein: Me is methyl, Et is ethyl, Ph is phenyl, tBu is tertiary butyl, PDI is polydispersity index, MAO is methylalumoxane, SMAO is supported methylalumoxane, NMR is nuclear magnetic resonance, ppm is part per million, THF is tetrahydrofuran, RPM is revolutions per minute.

As used herein, olefin polymerization catalyst(s) refer to any catalyst, such as an organometallic complex or compound that is capable of coordination polymerization addition where successive monomers are added in a monomer chain at the organometallic active center.

The terms “substituent,” “radical,” “group,” and “moiety” may be used interchangeably.

An “olefin,” alternatively referred to as “alkene,” is a linear, branched, or cyclic compound of carbon and hydrogen having at least one double bond. For purposes of this specification, when a polymer or copolymer is referred to as including an olefin, the olefin present in such polymer or copolymer is the polymerized form of the olefin. For example, when a copolymer is said to have an “ethylene” content of 35 wt % to 55 wt %, it is understood that the mer unit in the copolymer is derived from ethylene in the polymerization reaction and said derived units are present at 35 wt % to 55 wt %, based upon the weight of the copolymer. A “polymer” has two or more of the same or different mer units. A “homopolymer” is a polymer having mer units that are the same. A “copolymer” is a polymer having two or more mer units that are different from each other. A “terpolymer” is a polymer having three mer units that are different from each other. “Different” is used to refer to mer units indicates that the mer units differ from each other by at least one atom or are different isomerically. Accordingly, the definition of copolymer, as used herein, includes terpolymers. An “ethylene polymer” or “ethylene copolymer” (both of which are examples of a “polyethylene”) is a polymer or copolymer including at least 50 mol % ethylene derived units. A “propylene polymer” or “propylene copolymer” (both of which are examples of a “polypropylene”) is a polymer or copolymer including at least 50 mol % propylene derived units, and so on. An “ethylene polymer” or “ethylene copolymer” is a polymer or copolymer including at least 50 mol % ethylene derived units, a “propylene polymer” or “propylene copolymer” is a polymer or copolymer including at least 50 mol % propylene derived units, and so on.

As used herein, “polyethylene” can include “ethylene homopolymer”, “ethylene copolymer”, or combinations thereof. “Polypropylene” can include “propylene homopolymer”, “propylene copolymer”, or combinations thereof.

The term “alpha-olefin” refers to an olefin having a terminal carbon-to-carbon double bond in the structure thereof ((R″R″′)—C═CH₂, where R″ and R″′ can be independently hydrogen or any hydrocarbyl group; such as R″ is hydrogen and R″′ is an alkyl group). A “linear alpha-olefin” is an alpha-olefin defined in this paragraph wherein R″ is hydrogen, and R″′ is hydrogen or a linear alkyl group.

For the purposes of the present disclosure, ethylene shall be considered an alpha-olefin.

As used herein, and unless otherwise specified, the term “Cₙ” means hydrocarbon(s) having n carbon atom(s) per molecule, wherein n is a positive integer. The term “hydrocarbon” means a class of compounds containing hydrogen bound to carbon, and encompasses (i) saturated hydrocarbon compounds, (ii) unsaturated hydrocarbon compounds, and (iii) mixtures of hydrocarbon compounds (saturated and or unsaturated), including mixtures of hydrocarbon compounds having different values of n. Likewise, a “Cₘ-C_{y}” group or compound refers to a group or compound including carbon atoms at a total number thereof from m to y. Thus, a C₁-C₅₀ alkyl group refers to an alkyl group including carbon atoms at a total number thereof of about 1 to about 50.

Unless otherwise indicated, (e.g., the definition of “substituted hydrocarbyl”, “substituted aromatic”, etc.), the term “substituted” means that at least one hydrogen atom has been replaced with at least one non-hydrogen group, such as a hydrocarbyl group, a heteroatom, or a heteroatom containing group, such as halide (such as Br, Cl, F or I) or at least one functional group such as —NR*₂, —OR*, —SeR*, —TeR*, —PR*₂, —AsR*₂, —SbR*₂, —SR*, —BR*₂, —SiR*₃, -GeR*₃, —SnR*₃, —PbR*₃, where each R* is independently a hydrocarbyl or halocarbyl radical, and two or more R* may join together to form a substituted or unsubstituted saturated, partially unsaturated, or aromatic cyclic or polycyclic ring structure), or where at least one heteroatom has been inserted within a hydrocarbyl ring or chain.

The term “substituted hydrocarbyl” means a hydrocarbyl radical in which at least one hydrogen atom of the hydrocarbyl radical has been substituted with at least one heteroatom (such as halide, e.g., Br, Cl, F or I) or heteroatom-containing group (such as a functional group, e.g., —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, where each R* is independently a hydrocarbyl or halocarbyl radical, and two or more R* may join together to form a substituted or unsubstituted saturated, partially unsaturated, or aromatic cyclic or polycyclic ring structure), or where at least one heteroatom has been inserted within a hydrocarbyl ring or chain.

The term “substituted aromatic,” means an aromatic group having 1 or more hydrogen groups replaced by a hydrocarbyl, substituted hydrocarbyl, heteroatom or heteroatom containing group.

The term “substituted phenyl,” mean a phenyl group having 1 or more hydrogen groups replaced by a hydrocarbyl, substituted hydrocarbyl, heteroatom or heteroatom containing group.

The terms “hydrocarbyl radical,” “hydrocarbyl group,” or “hydrocarbyl” may be used interchangeably and are defined to mean a group including hydrogen and carbon atoms only. For example, a hydrocarbyl can be a C₁-C₁₀₀ radical that may be linear, branched, or cyclic, and when cyclic, aromatic or non-aromatic. Examples of such radicals may include, but are not limited to, alkyl groups such as methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, and aryl groups, such as phenyl, benzyl, naphthyl.

The terms “alkoxy” and “alkoxide” mean an alkyl or aryl group bound to an oxygen atom, such as an alkyl ether or aryl ether group/radical connected to an oxygen atom and can include those where the alkyl/aryl group is a C₁ to C₁₀ hydrocarbyl. The alkyl group may be straight chain, branched, or cyclic. The alkyl group may be saturated or unsaturated. Examples of suitable alkoxy radicals can include methoxy, ethoxy, n-propoxy, iso-propoxy, n-butoxy, iso-butoxy, sec-butoxy, tert-butoxy, phenoxyl.

The term “alkenyl” means a straight-chain, branched-chain, or cyclic hydrocarbon radical having one or more double bonds. These alkenyl radicals may be optionally substituted. Examples of suitable alkenyl radicals can include ethenyl, propenyl, allyl, 1,4-butadienyl, cyclopropenyl, cyclobutenyl, cyclopentenyl, cyclohexenyl, cycloctenyl, including their substituted analogues.

The terms “alkyl radical,” “alkyl group,” and “alkyl” are used interchangeably throughout this disclosure. For purposes of this disclosure, “alkyl radical” is defined to be C₁-C₁₀₀ alkyls that may be linear, branched, or cyclic. Examples of such radicals can include methyl, ethyl, n-propyl, isopropyl, n-butyl, isobutyl, sec-butyl, tert-butyl, pentyl, iso-amyl, hexyl, octyl, cyclopropyl, cyclobutyl, cyclopentyl, cyclohexyl, cyclooctyl, including their substituted analogues. Some examples of alkyl may include 1-methylethyl, 1-methylpropyl, 1-methylbutyl, 1-ethylbutyl, 1,3-dimethylbutyl, 1-methyl-1-ethylbutyl, 1,1-diethylbutyl, 1-propylpentyl, 1-phenylethyl, i-propyl, 2-butyl, sec-pentyl, sec-hexyl, and the like.

The term “aryl” or “aryl group” means an aromatic ring and the substituted variants thereof, such as phenyl, 2-methyl-phenyl, xylyl, 4-bromo-xylyl. Likewise, “heteroaryl” means an aryl group where a ring carbon atom (or two or three ring carbon atoms) has been replaced with a heteroatom, such as N, O, or S. As used herein, the term “aromatic” also refers to pseudoaromatic heterocycles which are heterocyclic substituents that have similar properties and structures (nearly planar) to aromatic heterocyclic ligands, but are not by definition aromatic; likewise the term aromatic also refers to substituted aromatics.

For nomenclature purposes, the following numbering schemes are used for cyclopentadienyl, indenyl, fluorenyl, cyclopenta[b]naphthalenyl (also termed benz[e]indenyl), cyclopenta[a]naphthalenyl (also termed benz[f]indenyl), tetrahydro-s-indacenyl and tetrahydro-as-indacenyl. The numbering schemes indicate the positions along the ring(s) to which a moiety can be connected. As an example, a moiety such as a phenanthridinyl moiety, can be coupled to the 4-position of an indenyl or a 1,5,6,7-tetrahydro-s-indacenyl. It should be noted that indenyl can be considered a cyclopentadienyl with a fused benzene ring. Analogously, fluorenyl can be considered a cyclopentadienyl with two fused benzene rings fused to the cyclopentadienyl ring. Each structure below is drawn and named as an anion.

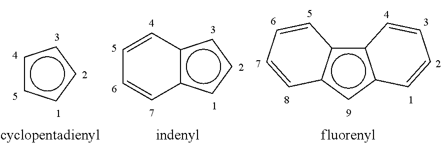

Partially hydrogenated polycyclic arenyl ligands retain the numbering scheme of the parent polycyclic arenyl ligand, namely the numbering schemes defined for indenyl, fluorenyl, cyclopenta[b]naphthalenyl, cyclopenta[a]naphthalenyl tetrahydro-s-indenyl, and tetrahydro-as-indacenyl ligands.

The term “arenyl” ligand is used herein to mean an unsaturated cyclic hydrocarbyl ligand that can consist of one ring, or two or more fused or catenated rings.

As used herein, the term “monocyclic arenyl ligand” is used herein to mean a substituted or unsubstituted monoanionic C₅ to C₁₀₀ hydrocarbyl ligand that contains an aromatic five-membered single hydrocarbyl ring structure (also referred to as a cyclopentadienyl ring).

As used herein, the term “polycyclic arenyl ligand” is used herein to mean a substituted or unsubstituted monoanionic C₉ to C₁₀₃ hydrocarbyl ligand that contains an aromatic five-membered hydrocarbyl ring (also referred to as a cyclopentadienyl ring) that is fused to one or two partially unsaturated, or aromatic hydrocarbyl ring structures which may be fused to additional saturated, partially unsaturated, or aromatic hydrocarbyl rings. Polycyclic arenyl ligands include, but are not limited to indenyl, fluorenyl, cyclopenta[b]naphthalenyl, cyclopenta[a]naphthalenyl tetrahydro-s-indenyl, and tetrahydro-as-indacenyl ligands.

Where isomers of a named alkyl, alkenyl, alkoxide, or aryl group exist (e.g., n-butyl, iso-butyl, sec-butyl, and tert-butyl), reference to an alkyl, alkenyl, alkoxide, or aryl group without specifying a particular isomer (e.g., butyl) expressly discloses all isomers (e.g., n-butyl, iso-butyl, sec-butyl, and tert-butyl).

The term “ring atom” means an atom that is part of a cyclic ring structure. By this definition, a benzyl group has six ring atoms and tetrahydrofuran has five ring atoms.

A heterocyclic ring is a ring having a heteroatom in the ring structure as opposed to a heteroatom substituted ring where a hydrogen on a ring atom is replaced with a heteroatom. For example, tetrahydrofuran is a heterocyclic ring and 4-N,N-dimethylamino-phenyl is a heteroatom-substituted ring. Other examples of heterocycles may include pyridine, imidazole, and thiazole.

As used herein, Mn is number average molecular weight, Mw is weight average molecular weight, and Mz is z average molecular weight, wt % is weight percent, and mol % is mole percent. Molecular weight distribution (MWD), also referred to as polydispersity (PDI), is defined to be Mw divided by Mn. Unless otherwise noted, all molecular weight units (e.g., Mw, Mn, Mz) are g/mol.

The terms “catalyst compound”, “catalyst complex”, “transition metal complex”, “transition metal compound”, “precatalyst compound”, and “precatalyst complex” are used interchangeably.

A “catalyst system” is a combination of at least one catalyst compound, at least one activator, an optional coactivator, and an optional support material. When “catalyst system” is used to describe such a pair before activation, it means the unactivated catalyst complex (precatalyst) together with an activator and, optionally, a coactivator. When it is used to describe such a pair after activation, it means the activated complex and the activator or other charge-balancing moiety. The catalyst compound may be neutral as in a precatalyst, or a charged species with a counter ion as in an activated catalyst system. For the purposes of the present disclosure and the claims thereto, when catalyst systems are described as including neutral stable forms of the components, it is well understood by one of ordinary skill in the art, that the ionic form of the component is the form that reacts with the monomers to produce polymers. A polymerization catalyst system is a catalyst system that can polymerize monomers to polymer. Furthermore, catalyst compounds and activators represented by formulae herein are intended to embrace both neutral and ionic forms of the catalyst compounds and activators.

An “anionic ligand” is a negatively charged ligand which donates one or more pairs of electrons to a metal ion. A “Lewis base” or “neutral donor ligand” is a neutrally charged ligand which donates one or more pairs of electrons to a metal ion. Examples of Lewis bases include ethylether, trimethylamine, pyridine, tetrahydrofuran, dimethylsulfide, and triphenylphosphine. The term “heterocyclic Lewis base” refers to Lewis bases that are also heterocycles. Examples of heteroyclic Lewis bases include pyridine, imidazole, thiazole, and furan.

A scavenger is a compound that can be added to facilitate polymerization by scavenging impurities. Some scavengers may also act as activators and may be referred to as coactivators. A coactivator, that is not a scavenger, may also be used in conjunction with an activator in order to form an active catalyst. In at least one embodiment, a coactivator can be pre-mixed with the transition metal compound to form an alkylated transition metal compound.

The term “continuous” means a system that operates without interruption or cessation for an extended period of time. For example a continuous process to produce a polymer would be one where the reactants are continually introduced into one or more reactors and polymer product is continually withdrawn.

A solution polymerization means a polymerization process in which the polymer is dissolved in a liquid polymerization medium, such as an inert solvent or monomer(s) or their blends. A solution polymerization can be homogeneous. A homogeneous polymerization is one where the polymer product is dissolved in the polymerization medium. Suitable systems may be not turbid as described in Oliveira, J. V. et al. (2000) “High-Pressure Phase Equilibria for Polypropylene-Hydrocarbon Systems,” Ind. Eng. Chem. Res., vol. 39, pp. 4627-4633.

A bulk polymerization means a polymerization process in which the monomers and or comonomers being polymerized are used as a solvent or diluent using little or no inert solvent as a solvent or diluent. A small fraction of inert solvent might be used as a carrier for catalyst and scavenger. A bulk polymerization system contains less than 25 wt % of inert solvent or diluent, such as less than 10 wt %, such as less than 1 wt %, such as 0 wt %.

The term “single catalyst compound” refers to a catalyst compound corresponding to a single structural formula, although such a catalyst compound may comprise and be used as a mixture of isomers, e.g., stereoisomers.

A catalyst system that utilizes a single catalyst compound means a catalyst system that is prepared using only a single catalyst compound in the preparation of the catalyst system. Thus, such a catalyst system is distinguished from, for example, “dual” catalyst systems, which are prepared using two catalyst compounds having different structural formulas, e.g., the connectivity between the atoms, the number of atoms, and/or the type of atoms in the two catalyst compounds is different. Thus, one catalyst compound is considered different from another if it differs by at least one atom, either by number, type, or connection. For example bisindenyl zirconium dichloride is different from (indenyl)(2-methylindenyl) zirconium dichloride which is different from (indenyl)(2-methylindenyl) hafnium dichloride. Catalyst compounds that differ only in that they are stereoisomers of each other are not considered to be different catalyst compounds. For example, rac-dimethylsilylbis(2-methyl 4-phenyl)hafnium dimethyl and meso-dimethylsilylbis(2-methyl 4-phenyl)hafnium dimethyl are considered to be not different.

The terms “cocatalyst” and “activator” are used herein interchangeably and are defined to be any compound which can activate any one of the catalyst compounds described above by converting the neutral catalyst compound to a catalytically active catalyst compound cation.

Noncoordinating anion (NCA) means an anion either that does not coordinate to the catalyst metal cation or that does coordinate to the metal cation, but only weakly. The term NCA is also defined to include multicomponent NCA-containing activators, such as N,N-dimethylanilinium tetrakis(pentafluorophenyl)borate, that contain an acidic cationic group and the non-coordinating anion. The term NCA is also defined to include neutral Lewis acids, such as tris(pentafluorophenyl)boron, that can react with a catalyst to form an activated species by abstraction of an anionic group. An NCA coordinates weakly enough that a neutral Lewis base, such as an olefinically or acetylenically unsaturated monomer can displace it from the catalyst center. Any metal or metalloid that can form a compatible, weakly coordinating complex may be used or contained in the noncoordinating anion. Suitable metals include, but are not limited to, aluminum, gold, and platinum. Suitable metalloids include, but are not limited to, boron, aluminum, phosphorus, and silicon. The term non-coordinating anion activator includes neutral activators, ionic activators, and Lewis acid activators. The terms “non-coordinating anion activator” and “ionizing activator” are used interchangeably herein.

The terms “process” and “method” are used interchangeably.

Additional definitions and conventions may be set forth below in other portions of the present disclosure.

### DETAILED DESCRIPTION

The present disclosure relates to metallocene catalyst compounds (such as ansa-metallocene catalyst compounds), to catalyst systems comprising such compounds, and to uses thereof. The inventors discovered that ansa-metallocene catalyst compounds having a phenanthridinyl moiety at the 4-position of an indenyl ligand can provide isotactic polypropylenes, propylene copolymers, and ethylene copolymers with high catalyst activities. Interestingly, high activities can be realized for catalyst compounds having a phenanthridinyl ligand even though a phenanthridinyl ligand is not aromatic. Aromatic ligands would be expected to provide electron density to an indenyl ligand coordinated to a catalytic metal, thus promoting catalyst activity. However, catalyst compounds of the present disclosure having phenanthridinyl ligands were found to have higher activities than comparative catalyst compounds having aromatic carbazole moieties bonded to the indenyl ligand. The isotactic polypropylenes, propylene copolymers, and ethylene copolymers formed using catalyst compounds of the present disclosure can have a high molecular weight.

The inventors also discovered that ansa-metallocene catalyst compounds can be disposed on a support (such as silica) to provide a supported catalyst compound. In general, supported catalysts tend to generate a lot of heat during polymerizations in a reactor which can fracture particles of the supported catalyst compound, creating fines which can foul the reactor. Supported catalyst compounds of the present disclosure have been found to provide reduced fracturing as compared to conventional supported catalyst compounds used for polypropylene production. Fracturing of supported catalyst compounds also promotes inconsistency of polymer properties formed from a polymerization. Thus, supported catalyst compounds of the present disclosure having a reduced propensity to fracture provide consistent polymer properties, such as properties of isotactic polypropylene. In addition, isotactic polypropylenes formed using supported catalyst compounds of the present disclosure can have a broad molecular weight capability due to high catalyst hydrogen response, useful processability (e.g., low melting point and broad polydispersity), and/or can be capable of forming products such as films having low haze (e.g., due to the low melting point). Having good response to hydrogen as chain transfer agent (or a handle to control Mw) is very useful due to an often limited temperature window that supported catalysts can operate without fouling. In addition to homopolypropylenes, supported catalysts of the present disclosure can be used in preparation of ethylene-propylene random copolymers, which may also be useful in films and injection molded articles of high clarity.

### Catalyst Compounds

This disclosure relates to metallocene catalyst compounds represented by Formula (I):

T_{y}LAMXₙ₋₂ (I)

wherein:
M is a group 3-6 metal, such as a group 4 metal;
n is the oxidation state of M;
A is a substituted monocyclic or polycyclic arenyl ligand bonded to M and is substituted by at least one phenanthridin-5-yl substituent;
L is a substituted or unsubstituted monocyclic or polycyclic arenyl ligand bonded to M, and optionally, may be the same as A;
T is a bridging group and when present is bonded to A and L;
y is 1 or 0 indicating the presence or absence of T; and
each X is independently a univalent anionic ligand, or two Xs are joined and bound to M to form a metallocycle ring, or two Xs are joined to form a chelating ligand, a diene ligand, or an alkylidene ligand.

In some embodiments, the at least one phenanthridin-5-yl substituent of Formula (I) is represented by Formula (Ia):

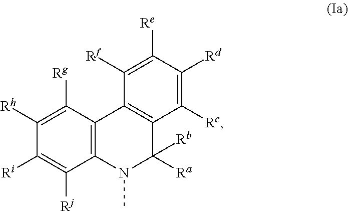

wherein each of R^{a}, R^{b}, R^{c}, R^{d}, R^{e}, R^{f}, R^{g}, R^{h}, Rⁱ, and R^{j} is independently hydrogen, hydrocarbyl, a heteroatom or a heteroatom-containing group, or any adjacent R^{c}, R^{d}, R^{e}, R^{f}, R^{g}, R^{h}, Rⁱ, and R^{j} may optionally be joined to form one or more hydrocarbyl rings or heterocyclic rings each having 5, 6, 7, or 8 ring atoms, and the dashed line indicates the bond to the monocyclic or polycyclic arenyl ligand of A and optionally L, of Formula (I).

In some embodiments, A of Formula (I) is selected from substituted cyclopentadienyl, indenyl, fluorenyl, cyclopenta[b]naphthalenyl, cyclopenta[a]naphthalenyl, tetrahydro-s-indacenyl, or tetrahydro-as-indacenyl. In some embodiments, a phenanthridin-5-yl substituent of Formula (I) is located at the 4-position of an indenyl, fluorenyl, cyclopenta[b]naphthalenyl, cyclopenta[a]naphthalenyl, tetrahydro-s-indacenyl, or tetrahydro-as-indacenyl. In some embodiments, a phenanthridin-5-yl substituent of Formula (I) is located at the 5 position of an indenyl, cyclopenta[a]naphthalenyl, or tetrahydro-as-indacenyl. In some embodiments, phenanthridin-5-yl substituent of Formula (I) is located at the 4-position of an indenyl, cyclopenta[b]naphthalenyl or tetrahydro-s-indacenyl, such as indenyl.

In some embodiments, L is selected from cyclopentadienyl, indenyl, fluorenyl, cyclopenta[b]naphthalenyl, cyclopenta[a]naphthalenyl, tetrahydro-s-indacenyl, or tetrahydro-as-indacenyl. L may be the same as or different than A.

In some embodiments, each X of Formula (I) is independently selected from a halide or C₁-C₅₀ hydrocarbyl, hydride, amide, alkoxide, sulfide, phosphide, or two of X are joined together to form a metallocycle ring, or two of X are joined to form a chelating ligand, a diene ligand, or an alkylidene.

In some embodiments, T of Formula (I) is a bridging group bonded to A and L and containing at least one Group 13, 14, 15, or 16 element, in particular boron or a Group 14, 15, or 16 element. Examples of suitable bridging groups include P(═S)R*, P(═Se)R*, P(═O)R*, R*₂C, R*₂Si, R*₂Ge, R*₂CCR*₂, R*₂CCR*₂CR*₂, R*₂CCR*₂CR*₂CR*₂, R*C-CR*, R*C═CR*CR*₂, R*₂CCR*═CR*CR*₂, R*C═CR*CR*═CR*, R*C═CR*CR*₂CR*₂, R*₂CSiR*₂, R*₂SiSiR*₂, R*₂SiOSiR*₂, R*₂CSiR*₂CR*₂, R*₂SiCR*₂SiR*₂, R*C═CR*SiR*₂, R*₂CGeR*₂, R*₂GeGeR*₂, R*₂CGeR*₂CR*₂, R*₂GeCR*₂GeR*₂, R*₂SiGeR*₂, R*C═CR*GeR*₂, R*B, R*₂C—BR*, R*₂C—BR *—CR*₂, R*₂C—O—CR*₂, R*₂CR*₂C—O—CR*₂CR*₂, R*₂C—O—CR*₂CR*₂, R*₂C—O—CR*═CR*, R*₂C—S—CR*₂, R*₂CR*₂C—S—CR*₂CR*₂, R*₂C—S—CR*₂CR*₂, R*₂C—S—CR*═CR*, R*₂C—Se—CR*₂, R*₂CR*₂C—Se—CR*₂CR*₂, R*₂C—Se—CR*₂CR*₂, R*₂C—Se—CR*═CR*, R*₂C—N═CR*, R*₂C—NR *—CR*₂, R*₂C—NR*—CR*₂CR*₂, R*₂C—NR*—CR*═CR*, R*₂CR*₂C—NR*—CR*₂CR*₂, R*₂C—P═CR*, R*₂C—PR*—CR*₂, O, S, Se, Te, NR*, PR*, AsR*, SbR*, O—O, S—S, R*N—NR*, R*P—PR*, O—S, O—NR*, O—PR*, S—NR*, S—PR*, and R*N—PR* where R* is hydrogen or a C₁-C₂₀ containing hydrocarbyl, halocarbyl, silylcarbyl or germylcarbyl substituent and optionally two or more adjacent R* may join to form a saturated, partially unsaturated or aromatic, cyclic or polycyclic substituent. Some examples of the bridging group T include CH₂, CH₂CH₂, SiMe₂, SiPh₂, SiMePh, Si(CH₂)₃, Si(CH₂)₄, O, S, NPh, PPh, NMe, PMe, NEt, NPr, NBu, PEt, PPr, Me₂SiOSiMe₂, and PBu.

In some embodiments, a metallocene catalyst compound of Formula (I) is represented by Formula (II):

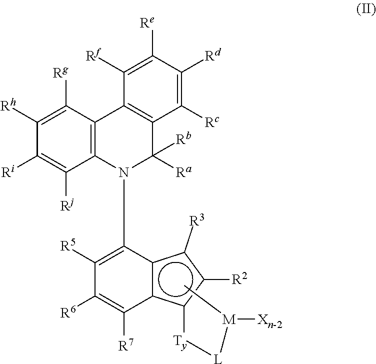

wherein:
M, T, y, L, X, n, R^{a}, R^{b}, R^{c}, R^{d}, R^{e}, R^{f}, R^{g}, R^{h}, Rⁱ, and R^{j} are as described above for Formula (I) and Formula (Ia); and
each of R², R³, R⁵, R^{6,} and R⁷ are independently hydrogen, hydrocarbyl, a heteroatom or heteroatom-containing group, and any adjacent R², R³, R⁵, R^{6,} and R⁷ may optionally be joined to form one or more substituted hydrocarbyl rings or heterocyclic rings each having 5, 6, 7, or 8 ring atoms.

In some embodiments of Formula (II), each of R², R³, R⁵, R⁶, and R⁷ is independently hydrogen or C₁-C₁₀ alkyl. In some embodiments, each of R², R³, R⁵, R⁶, and R⁷ is hydrogen. In some embodiments of Formula (II), Mis a group 4 metal, such as titanium (Ti), zirconium (Zr), or hafnium (Hf), such as Zr or Hf. In some embodiments of Formula (II), n is 4.

In some embodiments, each instance of R^{a}, R^{b}, R^{c}, R^{d}, R^{e}, R^{f}, R^{g}, R^{h}, Rⁱ, and R^{j} of Formula (II) is independently hydrogen, hydrocarbyl, silylcarbyl, alkoxyl, halide, or siloxyl.

In some embodiments, each instance of R^{a}, R^{b}, R^{c}, R^{d}, R^{e}, R^{f}, R^{g}, R^{h}, Rⁱ, and R^{j} of Formula (II) is independently hydrogen or C₁-C₁₀ hydrocarbyl, preferably hydrogen.

In some embodiments, a metallocene catalyst compound represented by Formula (I) is represented by Formula (III):

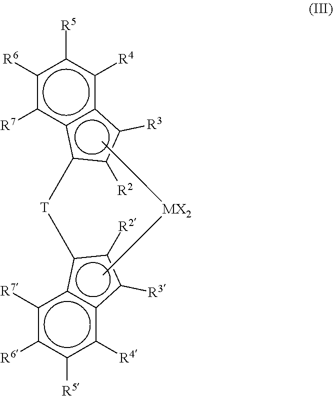

wherein:
M is a group 4 metal, such as titanium (Ti), zirconium (Zr), or hafnium (Hf);
each of R², R³, R⁵, R⁶, R⁷, R^{2′}, R^{3′}, R^{5′}, R^{6′}, and R^{7′} is independently hydrogen, hydrocarbyl, a heteroatom, or heteroatom-containing group, or one or more of R² and R³, R⁵ and R⁶, R⁶ and R⁷, R^{2′} and R^{3′}, R^{5′} and R^{6′}, and R^{6′} and R^{7′} are joined to form one or more saturated, partially saturated, or aromatic rings;
T represents the formula R⁸₂J or (R⁸)₄J₂ where J is C, Si, or Ge, and each R⁸ is independently hydrogen, halide, a C₁ to C₄₀ hydrocarbyl, or two R⁸ can form a cyclic structure including saturated, partially saturated, aromatic, or fused ring system;
each X is independently a halide or hydrocarbyl, hydride, amide, alkoxide, sulfide, phosphide, or a combination thereof, or two of X are joined together to form a metallocycle ring, or two of X are joined to form a chelating ligand, a diene ligand, or an alkylidene; and
each of R⁴ and R^{4′} is independently represented by Formula (IIIa):

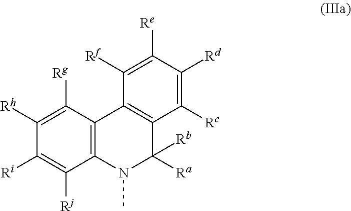

wherein each of R^{a}, R^{b}, R^{c}, R^{d}, R^{e}, R^{f}, R^{g}, R^{h}, Rⁱ, and R^{j} is independently hydrogen, hydrocarbyl, a heteroatom, or a heteroatom-containing group, or any adjacent R^{c}, R^{d}, R^{e}, R^{f}, R^{g}, R^{h}, Rⁱ, and R^{j} may optionally be joined to form one or more hydrocarbyl rings or heterocyclic rings each having 5, 6, 7, or 8 ring atoms, and the dashed line indicates the bond to a 4-position of an indenyl ligand of Formula (III).

In some embodiments, each of R², R³, R⁵, R⁶, R⁷, R^{2′}, R^{3′}, R^{5′}, R^{6′}, and R^{7′} of Formula (III) is independently hydrogen, hydrocarbyl, silylcarbyl, alkoxyl, halide, or siloxyl.

In some embodiments, each instance of R^{a}, R^{b}, R^{c}, R^{d}, R^{e}, R^{f}, R^{g}, R^{h}, Rⁱ, and R^{j} of Formula (III) and Formula (IIIa) is independently hydrogen, hydrocarbyl, silylcarbyl, alkoxyl, halide, or siloxyl.

In some embodiments, each instance of R^{a}, R^{b}, R^{c}, R^{d}, R^{e}, R^{f}, R^{g}, R^{h}, Rⁱ, and R^{j} of Formula (III) and Formula (IIIa) is independently hydrogen or C₁-C₁₀ hydrocarbyl, preferably hydrogen.

In some embodiments, each of R², R³, R⁵, R⁶, R⁷, R^{2′}, R^{3′}, R^{5′}, R^{6′}, and R^{7′} of Formula (III) is independently hydrogen or C₁-C₁₀ alkyl. Examples of suitable C₁ to C₂₀ alkyl groups include methyl, ethyl, propyl, butyl, pentyl, hexyl, heptyl, octyl, and isomers thereof.

In some embodiments of Formulas (I), (II), or (III), M is a group 4 metal, such as titanium (Ti), zirconium (Zr), or hafnium (Hf), such as Zr or Hf. In some embodiments of Formulas (I) or (II), n is 4.

In some embodiments of Formulas (I), (II), or (III), each X is a halide, such as chloro. In yet other embodiments, each X is a C₁-C₄ alkyl, such as methyl.

In some embodiments of Formulas (I), (II), or (III), (e.g., when y is 1 of Formula (I) and Formula (II)), T is represented by the formula R⁸₂J or (R⁸)₄J₂ where J is C, Si, or Ge, and each R⁸ is independently hydrogen, halide, C₁ to C₂₀ hydrocarbyl, and two R⁸ can form a cyclic structure including saturated, partially saturated, aromatic, or fused ring system. In some embodiments of Formulas (I), (II), or (III), T is selected from CH₂, CH₂CH₂, C(CH₃)₂, CPh₂, SiMe₂, SiPh₂, SiMePh, Si(CH₂)₃, Si(CH₂)₄, or Si(CH₂)₅.

In some embodiments of Formulas (I), (II), or (III), each X can be independently selected from hydrocarbyl, substituted hydrocarbyl, a heteroatom or heteroatom-containing group such as for example methyl, benzyl, trimethylsilyl, methyl(trimethylsilyl), neopentyl, ethyl, propyl, butyl, phenyl, hydrido, chloro, fluoro, bromo, iodo, trifluoromethanesulfonate, dimethylamido, diethylamido, dipropylamido, and diisopropylamido. In at least one embodiment of any of the formulae above, n is 4 and each X is independently chloro, benzyl or methyl.

In some embodiments of Formula (II), R² and R⁶ are independently hydrogen or C₁-C₂₀ hydrocarbyl. In some embodiments of Formula (II), R³, R⁷, R^{a}, R^{b}, R^{c}, R^{d}, R^{e}, R^{f}, R^{g}, R^{h}, Rⁱ, and R^{j} are hydrogen or C₁-C₂₀ hydrocarbyl. In some embodiments of Formula (II), R⁵ is hydrogen, C₁-C₂₀ hydrocarbyl, substituted C₁-C₂₀ hydrocarbyl, a heteroatom or a heteroatom-containing group.

In some embodiments of Formula (II), R² is hydrogen or C₁-C₂₀ hydrocarbyl (such as methyl). In some embodiments of Formula (II), each of R³, R⁵, R⁶, R⁷, R^{a}, R^{b}, R^{c}, R^{d}, R^{e}, R^{f}, R^{g}, R^{h}, Rⁱ, and R^{j} is hydrogen.

In some embodiments of Formula (III), each of R², R⁶, R^{2′}, and R^{6′} is independently hydrogen or C₁-C₂₀ hydrocarbyl. In some embodiments of Formula (III), each of R³, R⁷, R^{3′}, or R^{7′} is independently hydrogen. In some embodiments of Formula (III), each of R⁵ and R^{5′} is independently hydrogen, C₁-C₂₀ hydrocarbyl, a heteroatom, or heteroatom-containing group. In some embodiments of Formula (III) and Formula (IIIa), each instance of R^{a}, R^{b}, R^{c}, R^{d}, R^{e}, R^{f}, R^{g}, R^{h}, Rⁱ, and R^{j} is independently hydrogen or C₁-C₂₀ hydrocarbyl.

In some embodiments of Formula (III), R² and R^{2′} are independently hydrogen or C₁-C₂₀ hydrocarbyl (such as methyl). In some embodiments of Formula (III), each of R³, R⁵, R⁶, R⁷, R^{3′}, R^{5′}, R^{6′}, and R^{7′} is hydrogen. In some embodiments of Formula (III) and Formula (IIIa), each instance of R^{a}, R^{b}, R^{c}, R^{d}, R^{e}, R^{f}, R^{g}, R^{h}, Rⁱ, and R^{j} is hydrogen.

In some embodiments of Formula (III), each of R², R^{2′}, R⁶, and R^{6′} is independently hydrogen or C₁-C₂₀ hydrocarbyl. In some embodiments of Formula (III) and Formula (IIIa), each of R³, R^{3′}, R⁷, and R^{7′} is hydrogen, and each instance of R^{a}, R^{b}, R^{c}, R^{d}, R^{e}, R^{f}, R^{g}, R^{h}, Rⁱ, and R^{j} is hydrogen, and each of R⁵ and R^{5′} is independently hydrogen, C₁-C₂₀ hydrocarbyl, a heteroatom, or a heteroatom-containing group.

In some embodiments of Formula (III) and Formula (IIIa), each of R² and R^{2′} is independently hydrogen or C₁-C₂₀ hydrocarbyl (such as methyl), and each of R³, R^{3′}, R⁵, R^{5′}, R⁶, R^{6′}, R⁷, and R^{7′} is independently hydrogen, and each instance of R^{a}, R^{b}, R^{c}, R^{d}, R^{e}, R^{f}, R^{g}, R^{h}, Rⁱ, and R^{j} is hydrogen.

In some embodiments, a C₁-C₂₀ hydrocarbyl as used herein is a C₁-C₁₀ alkyl.

In some embodiments, a phenanthridin-5-yl substituent (e.g., of Formulas (Ia), (II), or (IIIa)) is selected from phenanthridin-5(6H)-yl, 4-methyl-phenanthridin-5(6H)-yl, 6-methyl-phenanthridin-5(6H)-yl, 1,10-dimethyl-phenanthridin-5(6H)-yl, 2,9-dimethyl-phenanthridin-5(6H)-yl, 3,4-dimethyl-phenanthridin-5(6H)-yl, 2,4-dimethyl-phenanthridin-5(6H)-yl, 6,6-dimethyl-phenanthridin-5(6H)-yl, 6,8-dimethyl-phenanthridin-5(6H)-yl, 3,6,6,9-tetramethyl-phenanthridin-5(6H)-yl, 3,6,8,9-tetramethyl-phenanthridin-5(6H)-yl, 6-isopropyl-phenanthridin-5(6H)-yl, 4-ethyl-phenanthridin-5(6H)-yl, 6-ethyl-phenanthridin-5(6H)-yl, benzo[k]phenanthridin-5(6H)-yl, benzo[j]phenanthridin-5(6H)-yl, benzo[b]phenanthridin-5(6H)-yl, benzo[a]phenanthridin-5(6H)-yl, 2-chloro-phenanthridin-5(6H)-yl, 3-chloro-phenanthridin-5(6H)-yl, 4-chloro-5,6-phenanthridin-5(6H)-yl, 1-bromo-phenanthridin-5(6H)-yl, 2-bromo-phenanthridin-5(6H)-yl, 2-fluoro-phenanthridin-5(6H)-yl, 8-fluoro-6-methyl-phenanthridin-5(6H)-yl, or 2-bromo-6,6-dimethylphenanthridin-5(6H)-yl.

In some embodiments, a catalyst compound represented by Formulas (I), (II), or (III) is selected from:
rac-dimethylsilanediyl-bis[η⁵-2-methyl-4-(phenanthridin-5(6H)yl) inden-1-yl]zirconium dichloride,
rac-dimethylsilanediyl-bis[η⁵-2-methyl-4-(phenanthridin-5(6H)yl) inden-1-yl]zirconium dimethyl,
rac-dimethylsilanediyl-bis[η⁵-2-methyl-4-(phenanthridin-5(6H)yl) inden-1-yl]hafnium dichloride,
rac-dimethylsilanediyl-bis[η⁵-2-methyl-4-(phenanthridin-5(6H)yl) inden-1-yl]hafnium dimethyl,
rac-dimethylsilanediyl-bis[η⁵-4-(phenanthridin-5(6H)yl) inden-1-yl]zirconium dichloride,
rac-dimethylsilanediyl-bis[η⁵-4-(phenanthridin-5(6H)yl) inden-1-yl]zirconium dimethyl,
rac-dimethylsilanediyl-bis[η⁵-4-(phenanthridin-5(6H)yl) inden-1-yl]hafnium dichloride,
rac-dimethylsilanediyl-bis[η⁵-4-(phenanthridin-5(6H)yl) inden-1-yl]hafnium dimethyl,
rac-dimethylsilanediyl-bis[η⁵-6-tert-butyl-5-methoxy-2-methyl-4-(phenanthridin-5(6H)yl)inden-1-yl]zirconium dichloride,
rac-dimethylsilanediyl-bis[η⁵-6-tert-butyl-5-methoxy-2-methyl-4-(phenanthridin-5(6H)yl)inden-1-yl]hafnium dichloride,
rac-dimethylsilanediyl-bis[η⁵-6-tert-butyl-5-methoxy-2-methyl-4-(phenanthridin-5(6H)yl)inden-1-yl]zirconium dimethyl,
rac-dimethylsilanediyl-bis[η⁵-6-tert-butyl-5-methoxy-2-methyl-4-(phenanthridin-5(6H)yl)inden-1-yl]hafnium dimethyl,
rac-dimethylsilylene-bis(η⁵-2,6,6-trimethyl-4-(phenanthridin-5(6H)yl)-1,5,6,7-tetrahydro-s-indacen-1-yl)zirconium dichloride,
rac-dimethylsilylene-bis(η⁵-2,6,6-trimethyl-4-(phenanthridin-5(6H)yl)-1,5,6,7-tetrahydro-s-indacen-1-yl)hafnium dichloride,
rac-dimethylsilylene-bis(η⁵-2,6,6-trimethyl-4-(phenanthridin-5(6H)yl)-1,5,6,7-tetrahydro-s-indacen-1-yl)zirconium dimethyl,
rac-dimethylsilylene-bis(η⁵-2,6,6-trimethyl-4-(phenanthridin-5(6H)yl)-1,5,6,7-tetrahydro-s-indacen-1-yl)hafnium dimethyl,
rac-dimethylsilylene-bis(η⁵-2-methyl-4-(phenanthridin-5(6H)yl)-1,5,6,7-tetrahydro-s-indacen-1-yl)zirconium dichloride,
rac-dimethylsilylene-bis(η⁵-2-methyl-4-(phenanthridin-5(6H)yl)-1,5,6,7-tetrahydro-s-indacen-1-yl)hafnium dichloride,
rac-dimethylsilylene-bis(η⁵-2-methyl-4-(phenanthridin-5(6H)yl)-1,5,6,7-tetrahydro-s-indacen-1-yl)zirconium dimethyl,
rac-dimethylsilylene-bis(η⁵-2-methyl-4-(phenanthridin-5(6H)yl)-1,5,6,7-tetrahydro-s-indacen-1-yl)hafnium dimethyl.

In at least one embodiment, two or more different catalyst compounds are present in a catalyst system. In at least one embodiment, two or more different catalyst compounds are present in the reaction zone of a reactor where the polymerization process(es) of the present disclosure occur. When two catalyst compounds are used in one reactor as a mixed catalyst system, the two catalyst compounds can be chosen such that the two are compatible. A simple screening method such as by ¹H or ¹³C NMR, known to those of ordinary skill in the art, can be used to determine which catalyst compounds are compatible. The same activator can be used for both catalyst compounds, however, two different activators, such as a non-coordinating anion activator and an alumoxane, can be used in combination. If one or more catalyst compounds contain an X¹ or X² ligand which is not a hydride, hydrocarbyl, or substituted hydrocarbyl, then the alumoxane may be contacted with the catalyst compound(s) prior to addition of the non-coordinating anion activator.

The two catalyst compounds may be used in any suitable ratio. Molar ratios of (A) transition metal compound to (B) transition metal compound can be (A: B) of 1:1000 to 1000:1, alternatively 1:100 to 500:1, alternatively 1:10 to 200:1, alternatively 1:1 to 100:1, alternatively 1:1 to 75:1, and alternatively 5:1 to 50:1. The suitable ratio chosen will depend on the exact catalyst compounds chosen, the method of activation, and the end product desired. In at least one embodiment, when using the two catalyst compounds, where both are activated with the same activator, mole percentages, based upon the molecular weight of the catalyst compounds, can be about 10% to about 99.9% A to about 0.1% to about 90% B, alternatively about 25% to about 99% A to about 0.5% to about 75% B, alternatively about 50% to about 99% A to about 1% to about 50% B, and alternatively about 75% to about 99% A to about 1% to about 10% B.

### Methods of Preparing the Catalyst Compounds

All air sensitive syntheses are carried out in nitrogen purged dry boxes. All solvents are available from commercial sources. Aluminum alkyls are available as hydrocarbon solutions from commercial sources. Methylalumoxane (“MAO”) is available from Albemarle as a 30 wt % solution in toluene.

Phenanthridin-5-yl substituents can be substituted onto aryl compounds, the reaction product of which is subsequently used a ligand for a catalyst compound of the present disclosure. To form the above reaction product, an aryl moiety having an amine substituent is treated with a bromo-biphenyl-carbaldehyde to form a methaneimine product. The imine product is treated with any suitable reducing agent (such as a borohydride, such as sodium cyanoborohydride) to form an amine product. The amine product is treated with any suitable cross-coupling reagent (such as a palladium catalyst) to undergo an intramolecular cross-coupling cyclization to form the aryl compound substituted with phenanthridin-5-yl.

Generally, the catalyst compounds of this disclosure may be synthesized similar to the schematic reaction procedure described in, for example, WO2016-196331 in paragraph [0080], where (i) is a deprotonation of the aryl compound (substituted with phenanthridin-5-yl) via a metal salt of alkyl anion (e.g., n-BuLi) to form an indenide; (ii) is reaction of indenide with an appropriate bridging precursor (e.g., Me₂SiCl₂); (iii) is a reaction of the above product with AgOTf (for embodiments where the catalyst compound is asymmetric); (iv) is reaction of the above triflate compound with another equivalent of indenide; (v) is deprotonation via an alkyl anion (e.g., n-BuLi) to form a dianion; and/or (vi) is reaction of the dianion with a metal halide (e.g., ZrCl₄) to form a catalyst compound of the present disclosure.

Metal-alkylated embodiments of catalyst compounds can be formed by treating the above catalyst compound (having dihalide substitutions at the metal) with an alkyl Grignard reagent to form a catalyst compound having dialkyl substitutions at the metal.

### Catalyst Systems

In one or more embodiments, the catalyst system of the present disclosure comprises an activator and any of the catalyst compounds described above. While the catalyst systems of the present disclosure may utilize any of the catalyst compounds described above in combination with each other or with one or more catalyst compounds not described above, in some embodiments, the catalyst systems utilize a single catalyst compound corresponding to one of the catalyst compounds of the present disclosure. In yet other embodiments, a catalyst system further includes a support material. In some embodiments, a support material is silica. In some embodiments, the activator includes one or more of alumoxanes, aluminum alkyls, ionizing activators, or combinations thereof.

In another embodiment, the present disclosure relates to a method for preparing a catalyst system by contacting a catalyst compound of the present disclosure with an activator, where the catalyst compound is a single catalyst compound and the single catalyst compound is the only catalyst compound contacted by an activator in said method. In yet another embodiment, the present disclosure relates to a method of polymerizing olefins comprising contacting at least one olefin with a catalyst system and obtaining a polyolefin. In still another embodiment, the present disclosure relates to a method of polymerizing olefins comprising contacting two or more different olefins with a catalyst system and obtaining a polyolefin. In a further embodiment, the present disclosure relates to a catalyst system comprising the catalyst compound of any of the embodiments described above, where the catalyst system includes a single catalyst compound. In a still further embodiment, the present disclosure relates to a catalyst system including the catalyst compound of any of the embodiments described above, where the catalyst system consists essentially of a single catalyst compound.

### Activators

The terms “cocatalyst” and “activator” are used herein interchangeably.

The catalyst systems described herein may comprise a catalyst complex as described above and an activator such as alumoxane or a non-coordinating anion and may be formed by combining the catalyst compounds described herein with activators in any manner known from the literature including combining them with supports, such as silica. The catalyst systems may also be added to or generated in solution polymerization or bulk polymerization (in the monomer). Catalyst systems of the present disclosure may have one or more activators and one, two or more catalyst components. Activators are defined to be any compound which can activate any one of the catalyst compounds described above by converting the neutral metal compound to a catalytically active metal compound cation. Non-limiting activators, for example, may include alumoxanes, aluminum alkyls, ionizing activators, which may be neutral or ionic, and conventional-type cocatalysts. Suitable activators may include alumoxane compounds, modified alumoxane compounds, and ionizing anion precursor compounds that abstract a reactive, σ-bound, metal ligand making the metal compound cationic and providing a charge-balancing non-coordinating or weakly coordinating anion, e.g., a non-coordinating anion.

In at least one embodiment, the catalyst system includes an activator, a catalyst compound of Formula (I), Formula (II), or Formula (III), and optional support.

### Alumoxane Activators

Alumoxane activators are utilized as activators in the catalyst systems described herein. Alumoxanes are generally oligomeric compounds containing —Al(R^{a″′})—O— sub-units, where R^{a ″′} is an alkyl group. Examples of alumoxanes include methylalumoxane (MAO), modified methylalumoxane (MMAO), ethylalumoxane and isobutylalumoxane. Alkylalumoxanes and modified alkylalumoxanes are suitable as catalyst activators, such as when the abstractable ligand is an alkyl, halide, alkoxide or amide. Mixtures of different alumoxanes and modified alumoxanes may also be used. It may be suitable to use a visually clear methylalumoxane. A cloudy or gelled alumoxane can be filtered to produce a clear solution or clear alumoxane can be decanted from the cloudy solution. A useful alumoxane is a modified methyl alumoxane (MMAO) cocatalyst type 3A (commercially available from Akzo Chemicals, Inc. under the trade name Modified Methylalumoxane type 3A, covered under patent number U.S. Pat. No. 5,041,584, which is incorporated by reference herein). Another useful alumoxane is solid polymethylaluminoxane as described in U.S. Pat. Nos. 9,340,630, 8,404,880, and 8,975,209, which are incorporated by reference herein.

When the activator is an alumoxane (modified or unmodified), in at least one embodiment, an amount of activator at up to a 5,000-fold molar excess Al/M over the catalyst compound (per metal catalytic site) may be used. The minimum activator-to-catalyst-compound may be a 1:1 molar ratio. Alternate ranges may include about 1:1 to about 500:1, alternately about 1:1 to about 200:1, alternately about 1:1 to about 100:1, or alternately about 1:1 to about 50:1.

In an alternate embodiment, little or no alumoxane is used in the polymerization processes described herein. For example, alumoxane can be present at zero mol %, alternately the alumoxane can be present at a molar ratio of aluminum to catalyst compound transition metal less than 500:1, such as less than 300:1, such as less than 100:1, such as less than 1:1.

### Ionizing/Non-Coordinating Anion Activators

The term “non-coordinating anion” (NCA) means an anion which either does not coordinate to a cation or which is only weakly coordinated to a cation thereby remaining sufficiently labile to be displaced by a Lewis base. “Compatible” non-coordinating anions are those which are not degraded to neutrality when the initially formed complex decomposes. Further, the anion will not transfer an anionic substituent or fragment to the cation so as to cause it to form a neutral transition metal compound and a neutral by-product from the anion. Non-coordinating anions useful in accordance with the present disclosure are those that are compatible, stabilize the transition metal cation in the sense of balancing its ionic charge at +1, and yet retain sufficient lability to permit displacement during polymerization. Suitable ionizing activators may include an NCA, such as a compatible NCA.

It is within the scope of the present disclosure to use an ionizing activator, neutral or ionic. It is also within the scope of the present disclosure to use neutral or ionic activators alone or in combination with alumoxane or modified alumoxane activators.

For descriptions of some suitable activators please see U.S. Pat. Nos. 8,658,556 and 6,211,105, incorporated by reference herein. Additional suitable activators are described in U.S. Patent Publication 2021/0179650, incorporated by reference herein.

In some embodiments, an activator can be one or more of N,N-dimethylanilinium tetrakis(perfluorophenyl)borate, N,N-dimethylanilinium tetrakis(perfluoronaphthyl)borate, dioctadecylmethylammonium tetrakis(perfluorophenyl)borate, N,N-dimethylanilinium tetrakis(perfluorobiphenyl)borate, N,N-dimethylanilinium tetrakis(3,5-bis(trifluoromethyl)phenyl)borate, triphenylcarbenium tetrakis(perfluoronaphthyl)borate, triphenylcarbenium tetrakis(perfluorobiphenyl)borate, triphenylcarbenium tetrakis(3,5-bis(trifluoromethyl)phenyl)borate, or triphenylcarbenium tetra(perfluorophenyl)borate.

In at least one embodiment, the activator is selected from one or more of a triaryl carbenium (such as triphenylcarbenium tetraphenylborate, triphenylcarbenium tetrakis(pentafluorophenyl)borate, triphenylcarbenium tetrakis-(2,3,4,6-tetrafluorophenyl)borate, triphenylcarbenium tetrakis(perfluoronaphthyl)borate, triphenylcarbenium tetrakis(perfluorobiphenyl)borate, or triphenylcarbenium tetrakis(3,5-bis(trifluoromethyl)phenyl)borate).

Suitable activator-to-catalyst ratio, e.g., all NCA activators-to-catalyst ratio may be about a 1:1 molar ratio. Alternate ranges include about 0.1:1 to about 100:1, alternately about 0.5:1 to about 200:1, alternately about 1:1 to about 500:1, alternately about 1:1 to about 1000:1. Suitable ranges can be about 0.5:1 to about 10:1, such as about 1:1 to about 5:1.

It is also within the scope of the present disclosure that the catalyst compounds can be combined with combinations of alumoxanes and NCA's (see for example, U.S. Pat. Nos. 5,153,157; 5,453,410; EP 0573120 B1; WO1994/007928; and WO1995/014044, incorporated herein by reference, which discuss the use of an alumoxane in combination with an ionizing activator).

Chain transfer agents may be used in polymerization processes of the present disclosure. Useful chain transfer agents can be hydrogen, alkylalumoxanes, a compound represented by the formula AlR₃, ZnR₂ (where each R is, independently, a C₁-C₈ aliphatic radical, such as methyl, ethyl, propyl, butyl, pentyl, hexyl octyl or an isomer thereof) or a combination thereof, such as diethyl zinc, methylalumoxane, trimethylaluminum, triisobutylaluminum, trioctylaluminum, or a combination thereof.

Furthermore, a catalyst system of the present disclosure may include a metal hydrocarbenyl chain transfer agent represented by the formula:

Al(R′)₃₋ᵥ(R″)ᵥ

where each R′ can be independently a C₁-C₃₀ hydrocarbyl group, and or each R″, can be independently a C₄-C₂₀ hydrocarbenyl group having an end-vinyl group; and v can be from 0.1 to 3.

### Alkane-Soluble Activators

Activators of the present disclosure may be those designed to have improved solubility in alkane solvents, such as the activators described in U.S. Pub. No. 2019/0330139, WO2021/025903, U.S. Pub. No. 2021/0122844, U.S. Pub. No. 2021/0121863, and U.S. Pub. No. 2021/0179537, incorporated herein by reference.

For example, activators, such as ammonium or phosphonium metallate or metalloid activator compounds, can include (1) ammonium or phosphonium groups and long-chain aliphatic hydrocarbyl groups and (2) metallate or metalloid anions, such as borates or aluminates.

In some embodiments, an activator compound is represented by Formula (AI):

$${{[ {R}^{1} {R}^{2} {R}^{3} E H ]}_{d}^{+} [ {M}^{k +} {Q}_{n} ]}^{d -} \qquad ( AI )$$

wherein:
E is nitrogen or phosphorus, such as nitrogen;
d is 1, 2 or 3 (such as 3); k is 1, 2, or 3 (such as 3); n is 1, 2, 3, 4, 5, or 6 (such as 4, 5, or 6); n−k=d (such as d is 1, 2 or 3; k is 3; n is 4, 5, or 6, such as when M is B, n is 4);
each of R¹, R², and R³ is independently H, optionally substituted C₁-C₄₀ alkyl (such as branched or linear alkyl), or optionally substituted C₅-C₅₀-aryl (alternately each of R¹, R², and R³ is independently unsubstituted or substituted with at least one of halide, C₅-C₅₀ aryl, C₆-C₃₅ arylalkyl, C₆-C₃₅ alkylaryl and, in the case of the C₅-C₅₀-aryl, C₁-C₅₀ alkyl); wherein R¹, R², and R³ together comprise 15 or more carbon atoms,
M is an element selected from group 13 of the Periodic Table of the Elements, such as B or Al, such as B; and
each Q is independently selected from the group consisting of a hydrogen, bridged or unbridged dialkylamido, halide, alkoxy, substituted alkoxy, aryloxy, substituted aryloxy, hydrocarbyl, substituted hydrocarbyl, halocarbyl, substituted halocarbyl, and halosubstituted-hydrocarbyl radical, such as a fluorinated aryl group, such fluoro-phenyl or fluoro-naphthyl, such as perfluorophenyl or perfluoronaphthyl.

In some embodiments of activator compounds represented by Formula (AI), at least one of R¹, R², and R³ is a linear or branched C₃-C₄₀ alkyl group (alternately such as a linear or branched C₇ to C₄₀ alkyl group).

The present disclosure also provides activator compounds represented by Formula (AI), described above where R¹ is a C₁-C₃₀ alkyl group (such as a C₁-C₁₀ alkyl group, such as C₁ to C₂ alkyl, such as methyl), wherein R¹ is optionally substituted, and each of R² and R³ is independently an optionally substituted branched or linear C₁-C₄₀ alkyl group or meta and/or para-substituted phenyl group, where the meta and para substituents are, independently, an optionally substituted C₁ to C₄₀ hydrocarbyl group, an optionally substituted alkoxy group, an optionally substituted silyl group, a halide, or a halide containing group, wherein R¹, R², and R³ together comprise 15 or more carbon atoms (such as 18 or more carbon atoms, such as 20 or more carbon atoms, such as 22 or more carbon atoms, such as 25 or more carbon atoms, such as 30 or more carbon atoms, such as 35 or more carbon atoms, such as 40 or more carbon atoms) and at least one of R¹, R², and R³ is a linear or branched alkyl (such as a C₃-C₄₀ branched alkyl, alternately C₇-C₄₀ branched alkyl).

The present disclosure further provides catalyst systems including activator compounds represented by Formula (AI), as described above where R¹ is methyl; and each of R² and R³ is independently C₁-C₄₀ branched or linear alkyl or C₅-C₅₀-aryl, wherein each of R¹, R², and R³ is independently unsubstituted or substituted with at least one of halide, C₅-C₅₀ aryl, C₆-C₃₅ arylalkyl, C₆-C₃₅ alkylaryl and, in the case of the C₅-C₅₀-aryl, C₁-C₅₀ alkyl; wherein R¹, R², and R³ together comprise 15 or more carbon atoms (such as 18 or more carbon atoms, such as 20 or more carbon atoms, such as 22 or more carbon atoms, such as 25 or more carbon atoms, such as 30 or more carbon atoms, such as 35 or more carbon atoms, such as 40 or more carbon atoms).

Activator compounds can include one or more of:
N,N-di(hydrogenated tallow)methylammonium [tetrakis(perfluorophenyl)borate],
N-methyl-4-nonadecyl-N-octadecylanilinium [tetrakis(perfluorophenyl)borate],
N-methyl-4-hexadecyl-N-octadecylanilinium [tetrakis(perfluorophenyl)borate],
N-methyl-4-tetradecyl-N-octadecylanilinium [tetrakis(perfluorophenyl)borate],
N-methyl-4-dodecyl-N-octadecylanilinium [tetrakis(perfluorophenyl)borate],
N-methyl-4-decyl-N-octadecylanilinium [tetrakis(perfluorophenyl)borate],
N-methyl-4-octyl-N-octadecylanilinium [tetrakis(perfluorophenyl)borate],
N-methyl-4-hexyl-N-octadecylanilinium [tetrakis(perfluorophenyl)borate],
N-methyl-4-butyl-N-octadecylanilinium [tetrakis(perfluorophenyl)borate],
N-methyl-4-octadecyl-N-decylanilinium [tetrakis(perfluorophenyl)borate],
N-methyl-4-nonadecyl-N-dodecylanilinium [tetrakis(perfluorophenyl)borate],
N-methyl-4-nonadecyl-N-tetradecylanilinium [tetrakis(perfluorophenyl)borate],
N-methyl-4-nonadecyl-N-hexadecylanilinium [tetrakis(perfluorophenyl)borate],
N-ethyl-4-nonadecyl-N-octadecylanilinium [tetrakis(perfluorophenyl)borate],
N-methyl-N,N-dioctadecylammonium [tetrakis(perfluorophenyl)borate],
N-methyl-N,N-dihexadecylammonium [tetrakis(perfluorophenyl)borate],
N-methyl-N,N-ditetradecylammonium [tetrakis(perfluorophenyl)borate],
N-methyl-N,N-didodecylammonium [tetrakis(perfluorophenyl)borate],
N-methyl-N,N-didecylammonium [tetrakis(perfluorophenyl)borate],
N-methyl-N,N-dioctylammonium [tetrakis(perfluorophenyl)borate],
N-ethyl-N,N-dioctadecylammonium [tetrakis(perfluorophenyl)borate],
N,N-di(octadecyl)tolylammonium [tetrakis(perfluorophenyl)borate],
N,N-di(hexadecyl)tolylammonium [tetrakis(perfluorophenyl)borate],
N,N-di(tetradecyl)tolylammonium [tetrakis(perfluorophenyl)borate],
N,N-di(dodecyl)tolylammonium [tetrakis(perfluorophenyl)borate],
N-octadecyl-N-hexadecyl-tolylammonium [tetrakis(perfluorophenyl)borate],
N-octadecyl-N-hexadecyl-tolylammonium [tetrakis(perfluorophenyl)borate],
N-octadecyl-N-tetradecyl-tolylammonium [tetrakis(perfluorophenyl)borate],
N-octadecyl-N-dodecyl-tolylammonium [tetrakis(perfluorophenyl)borate],
N-octadecyl-N-decyl-tolylammonium [tetrakis(perfluorophenyl)borate],
N-hexadecyl-N-tetradecyl-tolylammonium [tetrakis(perfluorophenyl)borate],
N-hexadecyl-N-dodecyl-tolylammonium [tetrakis(perfluorophenyl)borate],
N-hexadecyl-N-decyl-tolylammonium [tetrakis(perfluorophenyl)borate],
N-tetradecyl-N-dodecyl-tolylammonium [tetrakis(perfluorophenyl)borate],
N-tetradecyl-N-decyl-tolylammonium [tetrakis(perfluorophenyl)borate],
N-dodecyl-N-decyl-tolylammonium [tetrakis(perfluorophenyl)borate],
N-methyl-N-octadecylanilinium [tetrakis(perfluorophenyl)borate],
N-methyl-N-hexadecylanilinium [tetrakis(perfluorophenyl)borate],
N-methyl-N-tetradecylanilinium [tetrakis(perfluorophenyl)borate],
N-methyl-N-dodecylanilinium [tetrakis(perfluorophenyl)borate],
N-methyl-N-decylanilinium [tetrakis(perfluorophenyl)borate], and
N-methyl-N-octylanilinium [tetrakis(perfluorophenyl)borate].

### Optional Support Materials

In embodiments herein, the catalyst system may include an inert support material. The supported material can be a porous support material, for example, talc, and inorganic oxides. Other support materials include zeolites, clays, organoclays, or another organic or inorganic support material, or mixtures thereof.

The support material can be an inorganic oxide. The inorganic oxide can be in a finely divided form. Suitable inorganic oxide materials for use in catalyst systems herein may include groups 2, 4, 13, and 14 metal oxides, such as silica, alumina, and mixtures thereof. Other inorganic oxides that may be employed either alone or in combination with the silica, or alumina can be magnesia, titania, zirconia. Other suitable support materials, however, can be employed, for example, finely divided functionalized polyolefins, such as finely divided polyethylene. Examples of suitable supports may include magnesia, titania, zirconia, montmorillonite, phyllosilicate, zeolites, talc, clays. Also, combinations of these support materials may be used, for example, silica-chromium, silica-alumina, silica-titania. In at least one embodiment, the support material is selected from Al₂O₃, ZrO₂, SiO₂, SiO₂/Al₂O₃, SiO₂/TiO₂, silica clay, silicon oxide/clay, or mixtures thereof.

The support material, such as an inorganic oxide, can have a surface area of about 10 m²/g to about 700 m²/g, pore volume of about 0.1 cm³/g to about 4.0 cm³/g and average particle size of about 5 μm to about 500 μm. The surface area of the support material can be of about 50 m²/g to about 500 m²/g, pore volume of about 0.5 cm³/g to about 3.5 cm³/g and average particle size of about 10 μm to about 200 μm. For example, the surface area of the support material can be about 100 m²/g to about 400 m²/g, pore volume of about 0.8 cm³/g to about 3.0 cm³/g and average particle size can be about 5 μm to about 100 μm. The average pore size of the support material useful in the present disclosure can be of about 10 Å to about 1000 Å, such as about 50 Å to about 500 Å, and such as about 75 Å to about 350 Å. In at least one embodiment, the support material is a high surface area, amorphous silica (surface area=300 m²/gm; pore volume of 1.65 cm³/gm). For example, suitable silicas can be the silicas marketed under the tradenames of DAVISON™ 952 or DAVISON™ 955 by the Davison Chemical Division of W.R. Grace and Company. In other embodiments, DAVISON™ 948 is used. Alternatively, a silica can be ES-70™ silica (PQ Corporation, Malvern, Pennsylvania) that has been calcined, for example (such as at 875° C.).

The support material should be dry, that is, free or substantially free of absorbed water. Drying of the support material can be effected by heating or calcining at about 100° C. to about 1000° C., such as at least about 600° C. When the support material is silica, it is heated to at least 200° C., such as about 200° C. to about 850° C., and such as at about 600° C.; and for a time of about 1 minute to about 100 hours, about 12 hours to about 72 hours, or about 24 hours to about 60 hours. The calcined support material must have at least some reactive hydroxyl (OH) groups to produce supported catalyst systems of the present disclosure. The calcined support material is then contacted with at least one polymerization catalyst including at least one catalyst compound and an activator.

The support material, having reactive surface groups, such as hydroxyl groups, is slurried in a non-polar solvent and the resulting slurry is contacted with a solution of a catalyst compound and an activator. In at least one embodiment, the slurry of the support material is first contacted with the activator for a period of time of about 0.5 hour to about 24 hours, about 2 hours to about 16 hours, or about 4 hours to about 8 hours. The solution of the catalyst compound is then contacted with the isolated support/activator. In at least one embodiment, the supported catalyst system is generated in situ. In alternate embodiments, the slurry of the support material is first contacted with the catalyst compound for a period of time of about 0.5 hour to about 24 hours, about 2 hours to about 16 hours, or about 4 hours to about 8 hours. The slurry of the supported catalyst compound is then contacted with the activator solution.

The mixture of the catalyst(s), activator(s) and support is heated about 0° C. to about 70° C., such as about 23° C. to about 60° C., such as at room temperature. Contact times can be about 0.5 hours to about 24 hours, such as about 2 hours to about 16 hours, or about 4 hours to about 8 hours.

Suitable non-polar solvents are materials in which all of the reactants used herein, e.g., the activator and the catalyst compound, are at least partially soluble and which are liquid at polymerization reaction temperatures. Non-polar solvents can be alkanes, such as isopentane, hexane, n-heptane, octane, nonane, and decane, although a variety of other materials including cycloalkanes, such as cyclohexane, aromatics, such as benzene, toluene, and ethylbenzene, may also be employed.

In at least one embodiment, the support material is a supported methylalumoxane (SMAO), which is an MAO activator treated with silica (e.g., ES-70-875 silica).

### Polymerization Processes

The present disclosure also relates to polymerization processes where monomer (e.g., ethylene; propylene), and optionally a comonomer, are contacted with a catalyst system including an activator and at least one catalyst compound of the present disclosure. The catalyst compound and activator may be combined in any suitable order. The catalyst compound and activator may be combined prior to contacting with the monomer. Alternatively, the catalyst compound and activator may be introduced into the polymerization reactor separately, wherein the catalyst compound and activator subsequently react to form the active catalyst.

Monomers may include substituted or unsubstituted C₂ to C₄₀ alpha olefins, such as C₂ to C₂₀ alpha olefins, such as C₂ to C₁₂ alpha olefins, such as ethylene, propylene, butene, pentene, hexene, heptene, octene, nonene, decene, undecene, dodecene and isomers thereof. In at least one embodiment, the monomer includes ethylene and an optional comonomer including one or more C₃ to C₄₀ olefins, such as C₄ to C₂₀ olefins, such as C₆ to C₁₂ olefins. The C₃ to C₄₀ olefin monomers may be linear, branched, or cyclic. The C₃ to C₄₀ cyclic olefins may be strained or unstrained, monocyclic or polycyclic, and may optionally include heteroatoms and or one or more functional groups. In another embodiment, the monomer includes propylene and an optional comonomer including one or more ethylene or C₄ to C₄₀ olefins, such as C₄ to C₂₀ olefins, such as C₆ to C₁₂ olefins. The C₄ to C₄₀ olefin monomers may be linear, branched, or cyclic. The C₄ to C₄₀ cyclic olefins may be strained or unstrained, monocyclic or polycyclic, and may optionally include heteroatoms and or one or more functional groups.

Exemplary C₂ to C₄₀ olefin monomers and optional comonomers may include ethylene, propylene, butene, pentene, hexene, heptene, octene, nonene, decene, undecene, dodecene, norbornene, ethylidenenorbornene, vinylnorbornene, norbornadiene, dicyclopentadiene, cyclopentene, cycloheptene, cyclooctene, cyclooctadiene, cyclododecene, 7-oxanorbornene, 7-oxanorbornadiene, substituted derivatives thereof, and isomers thereof, such as hexene, heptene, octene, nonene, decene, dodecene, cyclooctene, 1,5-cyclooctadiene, 1-hydroxy-4-cyclooctene, 1-acetoxy-4-cyclooctene, 5-methylcyclopentene, cyclopentene, dicyclopentadiene, norbornene, norbornadiene, and their respective homologs and derivatives, such as norbornene, norbornadiene, and dicyclopentadiene.

Polymerization processes of the present disclosure can be carried out in any suitable manner. Any suitable suspension, homogeneous, bulk, solution, slurry, or gas phase polymerization process can be used. Such processes can be run in a batch, semi-batch, or continuous mode. Homogeneous polymerization processes and slurry processes can be used. A bulk homogeneous process can be used. Alternately, no solvent or diluent is present or added in the reaction medium, (except for the small amounts used as the carrier for the catalyst system or other additives, or amounts found with the monomer; e.g., propane in propylene). In another embodiment, the process is a slurry process. As used herein, the term “slurry polymerization process” means a polymerization process where a supported catalyst is employed, and monomers are polymerized on the supported catalyst particles. At least 95 wt % of polymer products derived from the supported catalyst are in granular form as solid particles (not dissolved in the diluent).

Suitable diluents/solvents for polymerization may include non-coordinating, inert liquids. Examples of diluents/solvents for polymerization may include straight and branched-chain hydrocarbons, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof, such as can be found commercially (e.g., Isopar™); perhalogenated hydrocarbons, such as perfluorinated C₄ to C₁₀ alkanes, chlorobenzene, and aromatic and alkylsubstituted aromatic compounds, such as benzene, toluene, mesitylene, and xylene. Suitable solvents may also include liquid olefins which may act as monomers or comonomers including ethylene, propylene, 1-butene, 1-hexene, 1-pentene, 3-methyl-1-pentene, 4-methyl-1-pentene, 1-octene, 1-decene, and mixtures thereof. In at least one embodiment, aliphatic hydrocarbon solvents are used as the solvent, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof. In another embodiment, the solvent is not aromatic, such as aromatics are present in the solvent at less than 1 wt %, such as less than 0.5 wt %, such as 0 wt % based upon the weight of the solvents.

In at least one embodiment, a feedstream to the reactor has a feed concentration of the monomers and comonomers for the polymerization is 60 vol % solvent or less, such as 40 vol % or less, such as 20 vol % or less, based on the total volume of the feedstream. In at least one embodiment, the polymerization is run in a bulk process.

Polymerizations can be run at any temperature and or pressure suitable to obtain the desired polymers. Suitable temperatures and or pressures include a temperature of about 0° C. to about 300° C., such as about 20° C. to about 200° C., such as about 35° C. to about 160° C., such as about 80° C. to about 160° C., such as about 85° C. to about 140° C. Polymerizations can be run at a pressure of about 0.1 MPa to about 25 MPa, such as about 0.45 MPa to about 6 MPa, or about 0.5 MPa to about 4 MPa.

In a suitable polymerization, the run time of the reaction can be up to about 300 minutes, such as about 5 minutes to about 250 minutes, such as about 10 minutes to about 120 minutes, such as about 20 minutes to about 90 minutes, such as about 30 minutes to about 60 minutes. In a continuous process the run time may be the average residence time of the reactor. In at least one embodiment, the run time of the reaction is up to about 45 minutes. In a continuous process the run time may be the average residence time of the reactor.

In at least one embodiment, hydrogen is present in the polymerization reactor at a partial pressure of about 0.001 psig to about 50 psig (0.007 kPa to 345 kPa), such as about 0.01 psig to about 25 psig (0.07 kPa to 172 kPa), such as about 0.1 psig to about 10 psig (0.7 kPa to 70 kPa).

In at least one embodiment, the hydrogen content is about 0.0001 ppm to about 2,000 ppm, such as about 0.0001 ppm to about 1,500 ppm, such as about 0.0001 ppm to about 1,000 ppm, such as about 0.0001 ppm to about 500 ppm. Alternately, hydrogen can be present at zero ppm.

In at least one embodiment, little or no alumoxane is used in the process to produce the polymers. For example, alumoxane can be present at zero mol %, alternately the alumoxane can be present at a molar ratio of aluminum to transition metal less than 500:1, such as less than 300:1, such as less than 100:1, such as less than 1:1.

Unless otherwise indicated, “catalyst productivity” is a measure of how many grams of polymer (P) are produced using a polymerization catalyst comprising W g of catalyst (cat), over a period of time of T hours; and may be expressed by the following formula: P/(T×W) and expressed in units of gPgcat⁻¹hr⁻¹. Unless otherwise indicated, “catalyst activity” is a measure of how active the catalyst is and is reported as the mass of product polymer (P) produced per mole of catalyst (cat) used (kgP/molcat) or as the mass of product polymer (P) produced per mass of catalyst (cat) used (gP/gcat). Catalyst activity may also be expressed over a period of time T of hours and reported as the mass of product polymer (P) produced per mole or millimole of catalyst (cat) used and expressed in units of gPmmolcat⁻¹hr⁻¹.

In at least one embodiment, according to the present disclosure, a catalyst system has a catalyst activity of greater than about 10,000 gPmmolcat⁻¹hr⁻¹, such as greater than about 100,000 gPmmolcat⁻¹hr⁻¹, such as greater than about 500,000 gPmmolcat⁻¹hr⁻¹, such as about 50,000 gPmmolcat⁻¹hr⁻¹ to about 1,200,000 gPmmolcat⁻¹hr⁻¹, such as about 200,000 gPmmolcat⁻¹hr⁻¹ to about 1,000,000 gPmmolcat⁻¹hr⁻¹, such as about 200,000 gPmmolcat⁻¹hr⁻¹ to about 500,000 gPmmolcat⁻¹hr⁻¹, alternatively about 500,000 gPmmolcat⁻¹hr⁻¹ to about 950,000 gPmmolcat⁻¹hr⁻¹, such as about 800,000 gPmmolcat⁻¹hr⁻¹ to about 950,000 gPmmolcat⁻¹hr⁻¹.

In at least one embodiment, the polymerization: 1) is conducted at temperatures of about 0° C. to about 300° C. (such as about 25° C. to about 250° C., such as about 50° C. to about 160° C., such as about 80° C. to about 140° C.); 2) is conducted at a pressure of atmospheric pressure to about 10 MPa (such as about 0.35 MPa to about 10 MPa, such as about 0.45 MPa to about 6 MPa, such as about 0.5 MPa to about 4 MPa); 3) is conducted in an aliphatic hydrocarbon solvent (such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof; such as where aromatics are present in the solvent at less than 1 wt %, such as less than 0.5 wt %, such as at 0 wt % based upon the weight of the solvents); 4) wherein the catalyst system used in the polymerization comprises less than 0.5 mol %, such as about 0 mol % alumoxane, alternately the alumoxane is present at a molar ratio of aluminum to transition metal less than 500:1, such as less than 300:1, such as less than 100:1, such as less than 1:1; 5) the polymerization occurs in one reaction zone; 6) optionally scavengers (such as trialkyl aluminum compounds) are absent (e.g., present at zero mol %, alternately the scavenger is present at a molar ratio of scavenger metal to transition metal of less than 100:1, such as less than 50:1, such as less than 15:1, such as less than 10:1); and 7) optionally hydrogen is present in the polymerization reactor at a partial pressure of about 0.001 psig to about 50 psig (0.007 kPa to 345 kPa) (such as about 0.01 psig to about 25 psig (0.07 kPa to 172 kPa), such as about 0.1 psig to about 10 psig (0.7 kPa to 70 kPa)). In at least one embodiment, the catalyst system used in the polymerization includes no more than one catalyst compound. A “reaction zone” also referred to as a “polymerization zone” is a vessel where polymerization takes place, for example a stirred-tank reactor or a loop reactor. When multiple reactors are used in a continuous polymerization process, each reactor is considered as a separate polymerization zone. For a multi-stage polymerization in a batch polymerization process, each polymerization stage is considered as a separate polymerization zone. In at least one embodiment, the polymerization occurs in one reaction zone. Room temperature is 23° C. unless otherwise noted.

Other additives may also be used in the polymerization, as desired, such as one or more scavengers, hydrogen, aluminum alkyls, or chain transfer agents such as alkylalumoxanes, a compound represented by the formula AlR³ or ZnR² (where each R is, independently, a C₁-C₈ aliphatic radical, such as methyl, ethyl, propyl, butyl, pentyl, hexyl octyl or an isomer thereof) or a combination thereof, such as diethyl zinc, methylalumoxane, trimethylaluminum, triisobutylaluminum, trioctylaluminum, or a combination thereof.

### Polyolefin Products

The present disclosure also relates to compositions of matter produced by the methods described herein.

In at least one embodiment, a process described herein produces C₂ to C₂₀ olefin homopolymers (e.g., ethylene homopolymer; propylene homopolymer), or C₂ to C₂₀ olefin copolymers (e.g., ethylene-octene, ethylene-propylene) and or propylene-alpha-olefin copolymers, such as C₃ to C₂₀ copolymers (such as propylene-ethylene, propylene-hexene, or propylene-octene).

A process of the present disclosure produces olefin polymers, such as polyethylene and propylene homopolymers and copolymers. In at least one embodiment, the polymers produced herein are homopolymers of ethylene or copolymers of ethylene having, for example, about 0.1 wt % to about 40 wt % (alternately about 5 wt % to about 40 wt %, such as about 10 wt % to about 35 wt %, such as about 10 wt % to about 20 wt %, alternatively about 20 wt % to about 30 wt %, such as about 25 wt % to about 30 wt %, of one or more C₃ to C₂₀ olefin comonomer (such as C₃ to C₁₂ alpha-olefin, such as propylene, butene, hexene, octene, decene, dodecene, such as propylene, butene, hexene, octene). For example, it has been discovered that catalyst compounds of the present disclosure can provide ethylene copolymers having high comonomer content, which can provide improved processability and/or toughness. In at least one embodiment, the monomer is ethylene and the comonomer is hexene or octene, such as about 5 wt % to about 40 wt % hexene or octene, such as about 10 wt % to about 35 wt % hexene or octene, such as about 15 wt % to about 25 wt % hexene or octene, alternatively about 25 wt % to about 33 wt %, based on the weight of the polymer.

In at least one embodiment, the polymers produced herein are homopolymers of propylene or are copolymers of propylene having, for example, about 0.1 wt % to about 22 wt % (alternately about 0.5 wt % to about 20 wt %, such as about 1 wt % to about 18 wt %, such as about 1 wt % to about 16 wt %) of one or more of C₂ or C₄ to C₂₀ olefin comonomer (such as ethylene or C₄ to C₁₂ alpha-olefin, such as ethylene, butene, hexene, octene, decene, dodecene, such as ethylene, butene, hexene, octene). In at least one embodiment, the monomer is propylene and the comonomer is ethylene, such as about 0.1 wt % to about 22 wt % ethylene, such as about 0.5 wt % to about 20 wt % ethylene, such as about 1 wt % to about 18 wt % ethylene, based on the weight of the polymer.

In at least one embodiment, a polymer produced herein has a unimodal or multimodal molecular weight distribution as determined by Gel Permeation Chromatography (GPC). By “unimodal” is meant that the GPC trace has one peak or inflection point. By “multimodal” is meant that the GPC trace has at least two peaks or inflection points. An inflection point is that point where the second derivative of the curve changes in sign (e.g., from negative to positive or vice versus).

In at least one embodiment, an ethylene homopolymer or ethylene copolymer of the present disclosure has an Mw about 10,000 g/mol to about 3,000,000 g/mol, such as about 100,000 g/mol to about 2,500,000 g/mol, such as about 200,000 g/mol to about 2,000,000 g/mol, such as about 250,000 g/mol to about 1,800,000 g/mol.

In at least one embodiment, an ethylene homopolymer or ethylene copolymer of the present disclosure has an Mn about 5,000 g/mol to about 1,500,000 g/mol, such as about 50,000 g/mol to about 1,250,000 g/mol, such as about 100,000 g/mol to about 1,000,000 g/mol, such as about 125,000 g/mol to about 900,000 g/mol.

In at least one embodiment, an ethylene homopolymer or ethylene copolymer of the present disclosure has an Mz about 50,000 g/mol to about 10,000,000 g/mol, such as about 100,000 g/mol to about 8,000,000 g/mol, such as about 500,000 g/mol to about 5,000,000 g/mol.

In at least one embodiment, an ethylene homopolymer or ethylene copolymer of the present disclosure has an Mw/Mn (PDI) value about 1 to about 5, such as about 1.5 to about 4, such as about 1.5 to about 3, such as about 1.5 to about 2.5.

In at least one embodiment, a propylene homopolymer or propylene copolymer of the present disclosure has an Mw about 10,000 g/mol to about 2,000,000 g/mol, such as about 50,000 g/mol to about 1,500,000 g/mol, such as about 100,000 g/mol to about 1,000,000 g/mol, such as about 150,000 g/mol to about 900,000 g/mol, alternatively about 250,000 g/mol to about 500,000 g/mol, such as about 250,000 g/mol to about 450,000 g/mol, such as about 300,000 g/mol to about 400,000 g/mol, alternatively about 100,000 g/mol to about 200,000 g/mol, alternatively about 600,000 g/mol to about 850,000 g/mol.

In at least one embodiment, a propylene homopolymer or propylene copolymer of the present disclosure has an Mn about 5,000 g/mol to about 1,000,000 g/mol, such as about 25,000 g/mol to about 750,000 g/mol, such as about 50,000 g/mol to about 500,000 g/mol, such as about 75,000 g/mol to about 500,000 g/mol, alternatively about 100,000 g/mol to about 250,000 g/mol, such as about 180,000 g/mol to about 225,000 g/mol, alternatively about 120,000 g/mol to about 170,000 g/mol.

In at least one embodiment, a propylene homopolymer or propylene copolymer of the present disclosure has an Mz about 30,000 g/mol to about 3,000,000 g/mol, such as about 100,000 g/mol to about 2,000,000 g/mol, such as about 150,000 g/mol to about 1,500,000 g/mol, such as about 600,000 g/mol to about 800,000 g/mol, alternatively about 800,000 g/mol to about 2,100,000 g/mol, such as about 900,000 g/mol to about 1,200,000 g/mol, alternatively about 1,200,000 g/mol to about 2,000,000 g/mol, such as about 1,300,000 g/mol to about 1,600,000 g/mol.

In at least one embodiment, a propylene homopolymer or propylene copolymer of the present disclosure has an Mw/Mn (PDI) value about 1 to about 8, such as about 1.5 to about 8, such as about 1.5 to about 3, such as about 1.5 to about 2.5, alternatively about 2 to about 7, such as about 3 to about 6.5, such as about 4 to about 6.

In at least one embodiment, a propylene homopolymer or propylene copolymer of the present disclosure can have a Tm (° C.) of about 120° C. to about 165° C., such as about 125° C. to about 164° C., about 135° C. to about 160° C., such as about 140° C. to about 155° C., alternatively about 145° C. to about 155° C.

In at least one embodiment, an ethylene homopolymer or ethylene copolymer of the present disclosure can have a Tm (° C.) of about 60° C. to about 135° C., such as about 70° C. to about 134° C., such as about 80° C. to about 130° C.

The stereoregularity of isotactic propylene homopolymers can be determined by the catalyst, total monomer concentrations, and reactor temperature. It is believed that isotactic propylene homopolymers (or copolymers) made according to processes of the present disclosure may comprise up to 99.99% m-dyads based on the total number of dyads present in the polymer, such as a meso dyad (m-dyad) content (m %) of about 85% to about 99.99%, such as about 95% to about 99.95%, such as about 99% to about 99.9%, such as about 98% to about 99%, as determined by ¹³C NMR, the remainder balance being r-dyad content (r %).

In some embodiments, an isotactic propylene homopolymer has an [mmmm] pentad content of about 95.0% to about 99.5%, such as about 96.0% to about 99.0%, such as about 96.2% to about 98.5%, as determined by ¹³C NMR. In some embodiments, an isotactic propylene homopolymer has an [rrrr] pentad content of about 0% to about 0.5%, such as about 0.0% to about 0.2%, such as about 0.01% to about 0.1%, as determined by ¹³C NMR. In some embodiments, an isotactic propylene homopolymer has an [mmmr] pentad content of about 0.1% to about 1%, such as about 0.2% to about 0.9%, such as about 0.3% to about 0.9%, as determined by ¹³C NMR. In some embodiments, an isotactic propylene homopolymer has an [rmmr] pentad content of about 0.1% to about 1%, such as about 0.2% to about 0.8%, such as about 0.2% to about 0.7%, as determined by ¹³C NMR. In some embodiments, an isotactic propylene homopolymer has an [mmrr] pentad content of about 0.1% to about 1%, such as about 0.2% to about 0.8%, such as about 0.3% to about 0.7%, as determined by ¹³C NMR. In some embodiments, an isotactic propylene homopolymer has an [mmrm+rmrr] pentad content of about 0.1% to about 1%, such as about 0.2% to about 0.8%, such as about 0.2% to about 0.7%, as determined by ¹³C NMR. In some embodiments, an isotactic propylene homopolymer has an [rmrm] pentad content of about 0.1% to about 1%, such as about 0.1% to about 0.5%, such as about 0.1% to about 0.4%, as determined by ¹³C NMR. In some embodiments, an isotactic propylene homopolymer has an [mrrr] pentad content of about 0% to about 0.1%, such as about 0%, as determined by ¹³C NMR. In some embodiments, an isotactic propylene homopolymer has an [mrrm] pentad content of about 0.1% to about 1%, such as about 0.1% to about 0.5%, such as about 0.1% to about 0.3%, as determined by ¹³C NMR.

Regio Defect Concentrations by ¹³Carbon (¹³C NMR): ¹³C NMR spectroscopy is used to measure stereo and regio defect concentrations of polypropylene. ¹³C NMR spectra are acquired as described in more detail below.

The regio defects each give rise to multiple peaks in the ¹³Carbon NMR spectrum, and these are all integrated and averaged (to the extent that they are resolved from other peaks in the spectrum), to improve the measurement accuracy. The chemical shift offsets of the resolvable resonances used in the analysis are tabulated below. The precise peak positions may shift as a function of NMR solvent choice.

| Regio defect | Chemical shift range (ppm) |
|---|---|
| 2,1-erythro | 42.3, 38.6, 36.0, 35.9, 31.5, 30.6, 17.6, 17.2 |
| 2,1-threo | 43.4, 38.9, 35.6, 34.7, 32.5, 31.2, 15.4, 15.0 |
| 3,1 insertion | 37.6, 30.9, 27.7 |

The stereo defects measured as “stereo defects/10,000 monomer units” are calculated from the sum of the intensities of mmrr, mmrm+rrmr, and rmrm resonance peaks times 5,000. The intensities used in the calculations are normalized to the total number of monomers in the sample polymer. Methods for measuring 2, 1 regio defects/10,000 monomers and 1,3 regio defects/10,000 monomers follow standard methods. Additional references include Grassi, A. et. al. (1988) “Microstructure of Isotactic Polypropylene Prepared with Homogeneous Catalysis: Stereoregularity, Regioregularity, and 1,3-Insertion,” Macromolecules, v.21, pp. 617-622 and Busico et al. (1994) “Effects of Regiochemical and Stereochemical Errors on the Course of Isotactic Propene Polyinsertion Promoted by Homogeneous Ziegler-Natta Catalysts,” Macromolecules, v.27, pp. 7538-7543. The average meso run length=10000/[(stereo defects/10000 C)+(2,1-regio defects/10000 C)+(1,3-regio-defects/10000 C)].

A low amount of regio defects provides a low or eliminated amount of haze of isotactic polypropylene films. It has been discovered that isotactic polypropylenes of the present disclosure can have a low amount of regio defects. In some embodiments, a polypropylene (or copolymer thereof) advantageously has less than 200 regio defects (defined as the sum of 2,1-erythro and 2,1-threo insertions, and 3,1-isomerizations) per 10,000 propylene units, alternatively more than 5, 10 or 15 and less than 200, 150, or 100 regio defects per 10,000 propylene units.

In some embodiments, a propylene homopolymer or propylene copolymer advantageously has less than 100 2,1-regio defects (defined as the sum of 2,1-erythro and 2, 1-threo insertions) per 10,000 propylene units, such as more than 5, 15 or 25 and less than 100, 75, or 65 2, 1-regio defects per 10,000 propylene units. In some embodiments, a propylene homopolymer or propylene copolymer advantageously has less than 100 1,3-regio defects (defined as 3,1 insertions/isomerizations) per 10,000 propylene units, such as more than 5, 7 or 15 and less than 75, 55, or 40 1,3-regio defects per 10,000 propylene units. In some embodiments, a propylene homopolymer or propylene copolymer advantageously has less than 150 total regio defects (defined as the sum of 3,1 insertions/isomerizations, 2, 1-erythro insertions and 2, 1-threo insertions) per 10,000 propylene units, such as more than 20, 30 or 40 and less than 150, 100, or 90 total regio defects per 10,000 propylene units.

In some embodiments, a propylene homopolymer or propylene copolymer has less than 100 stereo defects per 10,000 propylene units, alternatively more than 5, 15 or 30 and less than 100 or 85 stereo defects per 10,000 propylene units. In some embodiments, a propylene homopolymer has an average meso run length of about 20 to about 130, such as about 50 to about 120, such as about 60 to about 110. In some embodiments, the propylene homopolymer has a meso run length of greater than 50, alternatively greater than 60, alternatively greater than 70.

### GPC 4-D

Unless otherwise indicated, for purposes of the Claims, the distribution and the moments of molecular weight (Mw, Mn, Mz, Mw/Mn, etc.), the comonomer content are determined by using a high temperature Gel Permeation Chromatography (Polymer Char GPC-IR) equipped with a multiple-channel band-filter based Infrared detector IR⁵ with a multiple-channel band filter based infrared detector ensemble IR⁵ with band region covering about 2700 cm⁻¹ to about 3000 cm⁻¹ (representing saturated C—H stretching vibration), an 18-angle light scattering detector and a viscometer. Three Agilent PLgel 10-μm Mixed-B LS columns are used to provide polymer separation. Reagent grade 1,2,4-trichlorobenzene (TCB) (from Sigma-Aldrich) comprising ˜300 ppm antioxidant BHT can be used as the mobile phase at a nominal flow rate of ˜1.0 mL/min and a nominal injection volume of ˜200 μL. The whole system including transfer lines, columns, and detectors can be contained in an oven maintained at ˜145° C. A given amount of sample can be weighed and sealed in a standard vial with ˜10 μL flow marker (heptane) added thereto. After loading the vial in the auto-sampler, the oligomer or polymer may automatically be dissolved in the instrument with ˜8 mL added TCB solvent at ˜160° C. with continuous shaking. The sample solution concentration can be from ˜0.2 to ˜2.0 mg/ml, with lower concentrations used for higher molecular weight samples. The concentration, c, at each point in the chromatogram can be calculated from the baseline-subtracted IR⁵ broadband signal, I, using the equation: c=αI, where α is the mass constant determined with polyethylene or polypropylene standards. The mass recovery can be calculated from the ratio of the integrated area of the concentration chromatography over elution volume and the injection mass which is equal to the pre-determined concentration multiplied by injection loop volume. The conventional molecular weight (IR MW) is determined by combining universal calibration relationship with the column calibration which is performed with a series of monodispersed polystyrene (PS) standards ranging from 700 to 10M gm/mole. The MW at each elution volume is calculated with following equation:

$$log M = \frac{log ( {K}_{P S} / K )}{α + 1} + \frac{{α}_{P S} + 1}{α + 1} log {M}_{P S}$$

where the variables with subscript “PS” stand for polystyrene while those without a subscript are for the test samples. In this method, α_{PS}=0.67 and K_{PS}=0.000175, α and K for other materials are as calculated by GPC ONE™ software (Polymer Characterization, S.A., Valencia, Spain). Concentrations are expressed in g/cm3, molecular weight is expressed in g/mole, and intrinsic viscosity (hence K in the Mark-Houwink equation) is expressed in dL/g unless otherwise noted.

The comonomer composition is determined by the ratio of the IR⁵ detector intensity corresponding to CH₂ and CH₃ channel calibrated with a series of PE and PP homo/copolymer standards whose nominal value are predetermined by NMR or FTIR. In particular, this provides the methyls per 1000 total carbons (CH₃/1000TC) as a function of molecular weight. The short-chain branch (SCB) content per 1000TC (SCB/1000TC) is then computed as a function of molecular weight by applying a chain-end correction to the CH_{3/1000}TC function, assuming each chain to be linear and terminated by a methyl group at each end. The weight % comonomer is then obtained from the following expression in which f is 0.3, 0.4, 0.6, 0.8, and so on for C₃, C₄, C₆, C₈, and so on co-monomers, respectively:

$$w 2 = f * SCB / 1000 TC$$

The bulk composition of the polymer from the GPC-IR and GPC-4D analyses is obtained by considering the entire signals of the CH₃ and CH₂ channels between the integration limits of the concentration chromatogram. First, the following ratio is obtained

$$Bulk IR ratio = \frac{Area of {CH}_{3} signal within integration limits}{Area of {CH}_{2} signal within integration limits}$$

Then the same calibration of the CH₃ and CH₂ signal ratio, as mentioned previously in obtaining the CH3/1000TC as a function of molecular weight, is applied to obtain the bulk CH3/1000TC. A bulk methyl chain ends per 1000TC (bulk CH3end/1000TC) is obtained by weight-averaging the chain-end correction over the molecular-weight range. Then

$$w 2 b = f * CH 3 / 1000 TC \\ bulk SCB / 1000 TC = bulk CH 3 / 1000 TC - bulk CH 3 end / 1000 TC$$

and bulk SCB/1000TC is converted to bulk w2 in the same manner as described above.

The LS detector is the 18-angle Wyatt Technology High Temperature DAWN HELEOSII. The LS molecular weight (M) at each point in the chromatogram is determined by analyzing the LS output using the Zimm model for static light scattering (Light Scattering from Polymer Solutions; Huglin, M. B., Ed.; Academic Press, 1972.):

$$\frac{{K}_{o} c}{Δ R ( θ )} = \frac{1}{MP ( θ )} + 2 {A}_{2} c$$

Here, ΔR(θ) is the measured excess Rayleigh scattering intensity at scattering angle θ, c is the polymer concentration determined from the IR⁵ analysis, A2 is the second virial coefficient, P(θ) is the form factor for a monodisperse random coil, and Ko is the optical constant for the system:

$${K}_{o} = \frac{4 {π}^{2} {{n}^{2} ( dn / dc )}^{2}}{{λ}^{4} {N}_{A}}$$

where NA is Avogadro's number, and (dn/dc) is the refractive index increment for the system, n=1.500 for TCB at 145° C. and λ=665 nm. For analyzing polyethylene homopolymers, ethylene-hexene copolymers, and ethylene-octene copolymers, dn/dc=0.1048 ml/mg and A2=0.0015; for analyzing ethylene-butene copolymers, dn/dc=0.1048*(1−0.00126*w2) ml/mg and A2=0.0015 where w2 is weight percent butene comonomer.

A high temperature Agilent (or Viscotek Corporation) viscometer, which has four capillaries arranged in a Wheatstone bridge configuration with two pressure transducers, is used to determine specific viscosity. One transducer measures the total pressure drop across the detector, and the other, positioned between the two sides of the bridge, measures a differential pressure. The specific viscosity, ns, for the solution flowing through the viscometer is calculated from their outputs. The intrinsic viscosity, [η], at each point in the chromatogram is calculated from the equation [η]=ηs/c, where c is concentration and is determined from the IR⁵ broadband channel output. The viscosity MW at each point is calculated as M=K_{PS}M^{α}^{_{PS}}⁺¹/[η], where α_{PS} is 0.67 and K_{PS} is 0.000175.

### Blends

In some embodiments, the polymer (such as the polyethylene, polypropylene, or copolymers thereof) produced herein is combined with one or more additional polymers prior to being formed into a film, molded part or other article. Other useful polymers include polyethylene, isotactic polypropylene, highly isotactic polypropylene, syndiotactic polypropylene, random copolymer of propylene and ethylene, and or butene, and or hexene, polybutene, ethylene vinyl acetate, low density polyethylene (LDPE), linear low density polyethylene (LLDPE), high density polyethylene (HDPE), ethylene vinyl acetate, ethylene methyl acrylate, copolymers of acrylic acid, polymethylmethacrylate or any other polymers polymerizable by a high-pressure free radical process, polyvinylchloride, polybutene-1, isotactic polybutene, ABS resins, ethylene-propylene rubber (EPR), vulcanized EPR, ethylene-propylene-diene monomer (EPDM) polymers, block copolymers, styrenic block copolymers, polyamides, polycarbonates, polyethylene terephthalate (PET) resins, cross linked polyethylene, copolymers of ethylene and vinyl alcohol (EVOH), polymers of aromatic monomers such as polystyrene, poly-1 esters, polyacetal, polyvinylidine fluoride, polyethylene glycols, and or polyisobutylene.

In at least one embodiment, the polymer (such as the polyethylene, polypropylene) is present in the above blends, at about 10 wt % to about 99 wt %, based upon the weight of the polymers in the blend, such as about 20 wt % to about 95 wt %, such as at least about 30 wt % to about 90 wt %, such as at least about 40 wt % to about 90 wt %, such as at least about 50 wt % to about 90 wt %, such as at least about 60 wt % to about 90 wt %, such as at least about 70 to about 90 wt %.

Additionally, additives may be included in the blend, in one or more components of the blend, and or in a product formed from the blend, such as a film, as desired. Such additives are well known in the art, and can include, for example: fillers; antioxidants (e.g., hindered phenolics such as IRGANOX™ 1010 or IRGANOX™ 1076 available from Ciba-Geigy); phosphites (e.g., IRGAFOS™ 168 available from Ciba-Geigy); anti-cling additives; tackifiers, such as polybutenes, terpene resins, aliphatic and aromatic hydrocarbon resins, alkali metal and glycerol stearates, and hydrogenated rosins; UV stabilizers; heat stabilizers; anti-blocking agents; release agents; anti-static agents; pigments; colorants; dyes; waxes; silica; fillers; talc.

### Films

Any of the foregoing polymers, or blends thereof, may be used in a variety of end-use applications. Such applications include, for example, mono-or multi-layer blown, extruded, and or shrink films. These films may be formed by any number of well-known extrusion or coextrusion techniques, such as a blown bubble film processing technique, wherein the composition can be extruded in a molten state through an annular die and then expanded to form a uni-axial or biaxial orientation melt prior to being cooled to form a tubular, blown film, which can then be axially slit and unfolded to form a flat film. Films may be subsequently unoriented, uniaxially oriented, or biaxially oriented to the same or different extents. One or more of the layers of the film may be oriented in the transverse and or longitudinal directions to the same or different extents. The uniaxially orientation can be accomplished using suitable cold drawing or hot drawing methods. Biaxial orientation can be accomplished using tenter frame equipment or a double bubble processes and may occur before or after the individual layers are brought together. For example, an ethylene layer can be extrusion coated or laminated onto an oriented polypropylene layer or the polyethylene and polypropylene can be coextruded together into a film then oriented. Likewise, oriented polypropylene could be laminated to oriented polyethylene or oriented polyethylene could be coated onto polypropylene then optionally the combination could be oriented even further. However, in another embodiment the film is oriented to the same extent in both the MD and TD directions.

The films may vary in thickness depending on the intended application; however, films of a thickness of about 1 μm to about 50 μm can be suitable. Films intended for packaging can be about 10 μm to about 50 μm thick. The thickness of the sealing layer can be about 0.2 μm to about 50 μm. There may be a sealing layer on both the inner and outer surfaces of the film or the sealing layer may be present on only the inner or the outer surface.

### Experimental

The experimental methods and analytical techniques utilized in Examples below are described in this section.

Chemical structures and isomers of catalyst compounds of the present disclosure were determined by ¹H NMR. ¹H NMR data were typically collected at 23° C. in a 5 mm probe using a 400 MHz Bruker spectrometer with deuterated methylene chloride or deuterated benzene as the solvent.

### Pre-Catalyst Synthesis

1,2-Dibromoethane (Acros), p-toluenesulfonic acid (Aldrich), sodium cyanoborohydride (ABCR), sodium tert-butylate (Acros), tri(tert-butyl)phosphine (ABCR), N-methylimidazole (Acros), dimethyldichlorosilane (Acros), Pd₂(dba)₃ (dba=dibenzylideneacetone, Acros), ZrCl₄(THF)₂ (Aldrich), 2.5 M ⁿBuLi in hexanes (Acros), 2.9 M MeMgBr in ether (Aldrich), magnesium turnings (Acros), Na₂SO₄ (Aldrich), silica gel 60 (40-63 um, Merck), acetic acid (Acros), Celite (Aldrich), isopropanol (Acros) and methanol (Acros) were used as received. THF and diethyl ether were distilled over sodium benzophenoneketyl. Toluene (Merck), dichloromethane (Merck) and hexane (Merck) were dried over molecular sieves 4A (Acros) and then argon flushed. CDCl₃ (Deutero GmbH) was dried over molecular sieves 4A (Acros). 7-Bromo-2-methyl-1H-indene [Izmer, V. V. et al. (2006) “Palladium-Catalyzed Pathways to Aryl-Substituted Indenes: Efficient Synthesis of Ligands and the Respective ansa-Zirconocenes,” Organometallics, v.25(5), pp. 1217-1229], 2′-bromo-[1, 1′-biphenyl]-2-carbaldehyde [Tang, H.-J. et al. (2017) “Palladium-Catalyzed Fluoroarylation of gem-Difluoroalkenes,” Angew. Chem. Int. Ed., v.56(33), pp. 9872-9876], and trimethylsilylmethyl azide [Nishiyama, K.; et al. (1983) “Synthesis and Reactions of Trimethylsilylmethyl Azide,” J. Chem. Soc., Chem. Commun., pp. 1322-1323] were synthesized as previously described.

2-Methyl-1H-inden-4/7-amine. A mixture of 37.2 g of 4-bromo-2-methyl-1H-15 indene (178 mmol) and 37.1 mL of 1,2-dibromoethane (430 mmol) in 1000 mL

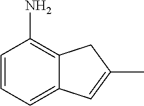

of THF was slowly added dropwise to 16.7 g of magnesium turnings (695 mmol) in 9 hours. The resulting solution was refluxed for additional 5 hours, then this mixture was allowed to cool down to room temperature. A solution of 20.7 g of trimethylsilylmethyl azide (160 mmol) in 200 mL of THF was slowly added dropwise to the obtained Grignard reagent. The resulting mixture was stirred overnight, then 300 ml of water was added dropwise to quench the reaction. The organic layer was separated, and the aqueous layer was extracted with diethyl ether (2×100 ml). The combined organic extract was dried over Na₂SO₄ and then rotary-evaporated. The crude product was distilled using the Kugelrohr apparatus at 130° C. (1 Torr). Crystallization of the residue from ethanol at −30° C. gave 15.5 g (51%) of the title product as orange crystals; m.p. 43° C. ¹H NMR (400 MHz, CDCl₃): δ7.15 (t, J=7.6 Hz, 1H), 6.85 (d, J=7.4 Hz, 1H), 6.55 (d, J=7.8 Hz, 1H), 6.53 (br.s, 1H), 3.63 (br.s, 2H), 3.12 (s, 2H), 2.22 (s, 3H). ¹³C{¹H} NMR (100 MHz, CDCl₃): δ146.7, 145.0, 141.0, 127.6, 127.5, 126.8, 111.34, 111.30, 39.5, 16.7. IR (ATR): 3417, 3388, 3318, 3213, 2907, 1628, 1607, 1582, 1473, 1449, 1436, 1393, 1380, 1291, 895, 816, 778, 768, 710.

1-(2′-Bromo-[1,1′-biphenyl]-2-yl)-N-(2-methyl-1H-inden-7-yl)methaneimine.

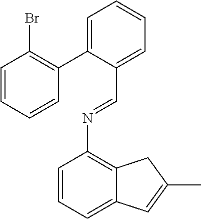 [SMILES: CC1=Cc2cccc(/N=C/c3ccccc3-c3ccccc3Br)c2C1]

To a solution of 10.2 g (70.2 mmol) 2-methyl-1H-inden-7-amine in 200 mL of toluene, 16.7 g (63.9 mmol) of 2′-bromo-[1,1′-biphenyl]-2-carbaldehyde and 0.5 g (2.9 mmol) of p-toluenesulfonic acid were added. The reaction mixture was refluxed with Dean-Stark for 7 hours. Then, the solution was cooled to room temperature and passed through a short pad of silica gel 60 (40-63 um). Solvent was evaporated, and the residue was recrystallized from ethanol affording yellow crystals. Yield: 14.9 g (60%). ¹H NMR (400 MHz, CDCl₃): δ8.45 (m, 1H), 8.30 (s, 1H), 7.72 (m, 1H), 7.58 (m, 2H), 7.36-7.43 (m, 2H), 7.26-7.33 (m, 2H), 7.22 (m, 2H), 7.11 (m, 1H), 6.70 (d, J=7.7 Hz, 1H), 6.52 (m, 1H), 3.34 (m, H), 2.19 (s, 3H).

N-((2′-Bromo-[1,1′-biphenyl]-2-yl)methyl)-2-methyl-1H-inden-7-amine. To a

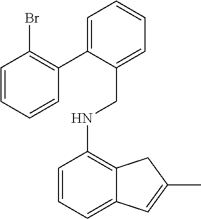 [SMILES: CC1=Cc2cccc(NCc3ccccc3-c3ccccc3Br)c2C1]

solution of 14.9 g (38.4 mmol) of 1-(2′-bromo-[1,1′-biphenyl]-2-yl)-N-(2-methyl-1H-inden-7-yl)methanimine in 100 mL of THF, a solution of 400 μL of acetic acid in 100 mL of methanol was added. Then, 3.6 g (57.6 mmol) of sodium cyanoborohydride was added. The reaction mixture was stirred overnight at 60° C. Next, the obtained mixture was poured in 300 mL of water and extracted with dichloromethane (3×100 ml). The organic extract was collected and dried over Na₂SO₄, then solvents were rotary evaporated. The title product was isolated by flash chromatography on silica gel 60 (40-63 um; eluent: hexane/ethylacetate=10/1, vol.). Yield: 11.4 g (76%). ¹H NMR (400 MHz, CDCl₃): δ7.66 (d, J=7.9 Hz, 1H), 7.56 (d, J=7.3 Hz, 1H), 7.29-7.42 (m, 4H), 7.19-7.25 (m, 2H), 7.07 (t, J=7.7 Hz, 1H), 6.72 (d, J=7.3 Hz, 1H), 6.45 (s, 1H), 6.36 (d, J=8.1 Hz, 1H), 4.22 (m, 2H), 3.74 (br.s, 1H), 3.02 (s, 2H), 2.16 (s, 3H).

5-(2-Methyl-1H-inden-4/7-yl)-5,6-dihydrophenanthridine. To a solution of

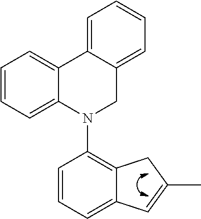 [SMILES: CC1=Cc2cccc(N3Cc4ccccc4-c4ccccc43)c2C1]

5.75 g (14.7 mmol) of N-((2′-bromo-[1,1′-bipheny]-2-yl)methyl)-2-methyl-1H-inden-7-amine and 3.53 g (36.9 mmol) sodium tert-butylate in 100 mL of toluene, a solution of 179 mg (0.88 mmol) tri(tert-butyl)phosphine and 254 mg (0.44 mmol) Pd₂(dba)₃ in 10 mL of toluene was added. After heating under argon at 100° C. for 24 hours the reaction 30 mixture was poured into 1 L of water, the crude product was extracted with toluene (2×300 ml). The extracts were combined and dried over anhydrous Na₂SO₄. The solvent was rotary evaporated. The mixture was separated by flash chromatography on silica gel 60 (40-63 um; eluent: hexane/dichloromethane=10/1, vol.) affording fractions containing the required product. The fractions were concentrated in vacuum, and the residue was recrystallized from hexane/isopropanol mixture. Yield: 3.13 g (69%) as a mixture of two isomers with ratio ca. 1:1. ¹H NMR (400 MHz, CDCl₃): δ7.84 (m, 2H), 7.36-7.42 (m, 2H), 7.08-7.30 (m, 5H), 6.91-6.94 (m, 1H), 6.47-6.53 (m, 1H), 6.28 (m, 1H), 4.80 (s, 2H), 3.38 (s, 1H), 3.08 (s, 1H), 2.09 (m, 3H).

A mixture of rac- and meso-bis(2-methyl-4-(phenanthridin-5(6H)-yl)-1H-inden-1-yl)dimethylsilanes. To a solution of 6.5 g (21.0 mmol) of 5-(2-methyl-1H-inden-4/7-

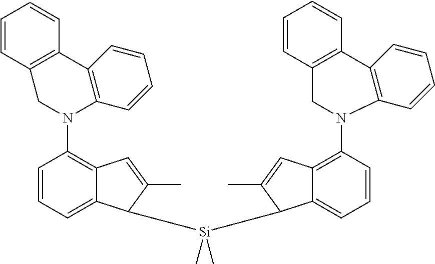 [SMILES: CC1=Cc2c(cccc2N2Cc3ccccc3-c3ccccc32)C1[Si](C)(C)C1C(C)=Cc2c1cccc2N1Cc2ccccc2-c2ccccc21]

yl)-5,6-dihydrophenanthridine in 250 mL of ether, 8.4 mL (21.0 mmol) of 2.5 M ⁿBuLi in hexanes was added in one portion at 0° C. This mixture was stirred overnight at room temperature, then the resulting mixture was cooled to −50° C., and 20 mg (0.5 mmol) of N-methylimidazole was added. Further on, 1.36 g (10.5 mmol) of dimethyldichlorosilane was added in one portion. The obtained mixture was stirred overnight at room temperature, then passed through a short pad of silica gel 60 (40-63 um) which was additionally washed by 2×25 mL of dichloromethane. The combined filtrate was evaporated under reduced pressure, and the resulting crude product was purified by flash chromatography on silica gel 60 (40-63 um, eluent: hexane/dichloromethane, 5:1, vol.). Yield: 4.1 g (58%) as a mixture of two isomers with ratio ca. 1:1. ¹H NMR (400 MHz, CDCl₃): δ7.81 (m, 4H), 7.36-7.44 (m, 4H), 7.13-7.28 (m, 8H), 7.02 (m, 2H), 6.89 (m, 2H), 6.44 (m, 2H), 6.37 (m, 2H), 4.86 (m, 2H), 4.73 (m, 2H), [3.83 (s), 3.79 (s), 2H], [2.18 (s), 2.11 (s), 6H], [−0.21 (s), −0.25 (s), −0.26 (s), 6H].

Rac- and meso-dimethylsilanediylbis[η⁵-2-methyl-4-(phenanthridin-5(6H)-yl)-1H-inden-1-yl]zirconium dichlorides. To a cooled to 0° C. solution of 3.5 g (5.2 mmol,

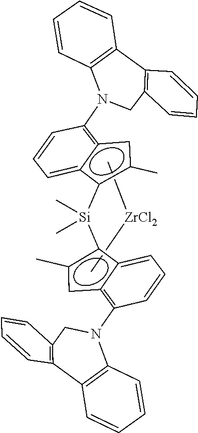

1 equiv.) of a mixture of rac- and meso-bis(2-methyl-4-(phenanthridin-5(6H)-yl)-1H-inden-1-yl)dimethylsilanes in 120 mL of ether, 4.2 mL (10.4 mmol, 2 equivs.) of 2.5 M ⁿBuLi in hexanes was added in one portion. This mixture was stirred overnight at room temperature, then the resulting solution was cooled to −50° C., and 1.96 g (5.2 mmol, 1 equiv.) of ZrCl₄(THF)₂ was added. The reaction mixture was stirred for 24 hours at room temperature. The volatiles were evaporated to dryness. The residue was treated with 170 mL of hot toluene, and the formed suspension was filtered while hot through a short pad of Celite to get rid of LiCl. The resulting solution was concentrated in vacuum, and the residue was recrystallized from toluene to give three crops of the title product as follows: (1) 420 mg, rac/meso=1.0/1.3 (10%), (2) 400 mg, rac/meso=1.0/1.3 (9%), and (3) 450 mg, rac/meso=1.0/1.5 (10%). The first crop: Anal. calc. for C₄₈H₄₀Cl₂N₂SiZr: C, 69.04; H, 4.83; N, 3.35. Found: C, 69.25; H, 5.02; N, 3.20. ¹H NMR (400 MHz, CDCl₃), rac-complex: δ7.74-7.82 (m, 4H), 7.41 (m, 2H), 7.35 (m, 2H), 7.18-7.29 (m, 4H), 7.02-7.08 (m, 3H), 6.94-7.01 (m, 4H), 6.79 (m, 1H), 6.72 (m, 2H), 6.68 (s, 2H), 5.02 (d, J=13.6 Hz, 2H), 4.79 (d, J=13.6 Hz, 2H), 2.22 (s, 6H), 1.31 (s, 6H); meso-complex: δ7.74-7.82 (m, 4H), 7.45 (m, 2H), 7.35 (m, 2H), 7.18-7.29 (m, 4H), 7.02-7.08 (m, 3H), 6.94-7.01 (m, 4H), 6.81 (m, 1H), 6.45-6.47 (m, 4H), 4.96 (d, J=13.4 Hz, 2H), 4.73 (d, J=13.4 Hz, 2H), 2.38 (s, 6H), 1.46 (s, 3H), 1.22 (s, 3H).

Rac-dimethylsilanediylbis[η⁵-2-methyl-4-(phenanthridin-5(6H)-yl)-1H-inden-1-yl]dimethylzirconium (Cat ID=A). To 820 mg (0.98 mmol) of a suspension of a ca. 1.0:1.3

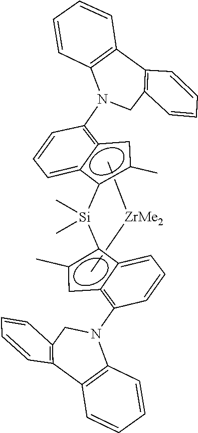

mixture of rac- and meso-dimethylsilanediylbis[η⁵-2-methyl-4-(phenanthridin-5(6H)-yl)-1H-inden-1-yl]zirconium dichlorides in 50 mL of toluene, 3.4 mL of 2.9 M MeMgBr (9.8 mmol) in ether was added at room temperature. This mixture was stirred for 24 hours at 100° C. then volatiles were evaporated to dryness in vacuum. To the residue 100 mL of toluene was added, and the obtained mixture was heated up to 100° C. Further on, this mixture was passed through a short pad of Celite to get rid of magnesium salts and an excess of MeMgBr. The filtrate was concentrated in vacuum, and the residue was recrystallized from toluene/hexane mixture that gave 187 mg (24%) of the title rac-complex contaminated with 5% of meso-isomer. Anal. calc. for C₅₀H₄₆N₂SiZr: C, 75.61; H, 5.84; N, 3.53. Found: C, 75.83; H, 5.99; N, 3.36. ¹H NMR (400 MHz, C₆D₆): δ7.71 (m, 2H), 7.60 (m, 2H), 7.10-7.20 (m, 4H), 6.95-7.04 (m, 6H), 6.88 (m, 2H), 6.69-6.83 (m, 6H), 6.57 (s, 2H), 4.69 (d, J=13.2 Hz, 2H), 4.58 (d, J=13.2 Hz, 2H), 1.78 (s, 6H), 0.78 (s, 6H), −1.03 (s, 6H).

### Supported Catalyst Preparation

Preparation of Silica Supported MAO (sMAO-1)

20.0 g of DM-L403 SMAO (AGC chemicals, calcined at 200° C.) was suspended in about 100 mL of toluene in a Celstir® flask While stirring, a solution of MAO (31.8 g, 30% in toluene) was slowly added via pipette. The slurry was allowed to stir for 1 hour and was then heated to 100° C. for 2.5 hours. Upon cooling for 30 minutes, the mixture was filtered, and the solid was washed with toluene (2×20 mL) and pentane (2×20 mL) and dried in vacuo overnight to afford the final 28.5 g of SMAO isolated as free flowing solid.

### Preparation of Supported Catalyst A:

0.505 g of sMAO-1 was slurried in toluene and placed on a vortexer. Triisobutyl aluminum (TIBAL) (0.178 mL of 1M solution in hexane) was then added to the vortexing mixture. The mixture was vortexed for 15 minutes at room temperature. After 15 minutes, a solution of pre-catalyst A (13.5 mg in toluene) was added to afford a dark green slurry. The slurry was vortexed for 2.5 hours, the mixture was then filtered and the resulting dark green solids were washed with toluene (2×5 mL) and pentane (2×5 mL) and dried in vacuo. The obtained supported catalyst A was suspended in mineral oil to make 5 wt % slurry.

### Small Scale Solution Polymerization Examples

Solutions of the pre-catalysts were made using toluene (ExxonMobil Chemical—anhydrous, stored under N₂) (98%). Pre-catalyst solutions were typically 0.5 mmol/L.

Solvents, polymerization grade toluene and/or isohexanes were supplied by ExxonMobil Chemical Co. and are purified by passing through a series of columns: two 500 cc Oxyclear cylinders in series from Labclear (Oakland, Calif.), followed by two 500 cc columns in series packed with dried 3 Å mole sieves (8-12 mesh; Aldrich Chemical Company), and two 500 cc columns in series packed with dried 5 Å mole sieves (8-12 mesh; Aldrich Chemical Company).

1-octene (C₈; 98%, Aldrich Chemical Company) was dried by stirring over NaK overnight followed by filtration through basic alumina (Aldrich Chemical Company, Brockman Basic 1).

Polymerization grade ethylene (C₂) was used and further purified by passing it through a series of columns: 500 cc Oxyclear cylinder from Labclear (Oakland, Calif.) followed by a 500 cc column packed with dried 3 Å mole sieves (8-12 mesh; Aldrich Chemical Company), and a 500 cc column packed with dried 5 Å mole sieves (8-12 mesh; Aldrich Chemical Company).

Polymerization grade propylene (C₃) was used and further purified by passing it through a series of columns: 2250 cc Oxiclear cylinder from Labclear followed by a 2250 cc column packed with 3 Å mole sieves (8-12 mesh; Aldrich Chemical Company), then two 500 cc columns in series packed with 5 Å mole sieves (8-12 mesh; Aldrich Chemical Company), then a 500 cc column packed with Selexsorb CD (BASF), and finally a 500 cc column packed with Selexsorb COS (BASF).

Activation of the pre-catalysts was either by methylalumoxane (MAO, 10 wt % in toluene, Albemarle Corp.; Act ID=M), dimethylanilinium tetrakisperfluorophenylborate (Boulder Scientific or W. R. Grace & Co.; Act ID=D). MAO was used as a 0.5 wt % or 1.0 wt % in toluene solution. Micromoles of MAO reported in the experimental section are based on the micromoles of aluminum in MAO. The formula weight of MAO is 58.0 grams/mole. Dimethylanilinium tetrakisperfluorophenylborate were typically used as a 0.5 mmol/L solution in toluene.

For polymerization runs using dimethylanilinium tetrakisperfluorophenylborate, tri-n-octylaluminum (TnOAl, Neat, AkzoNobel) was also used as a scavenger prior to introduction of the activator and pre-catalyst into the reactor. TnOAl was typically used as a 5 mmol/L solution in toluene.

### Reactor Description and Preparation:

Polymerizations were conducted in an inert atmosphere (N₂) drybox using autoclaves equipped with an external heater for temperature control, glass inserts (internal volume of reactor=23.5 mL for C₂ and C₂/C₈; 22.5 mL for C₃ and C₂/C₃ runs), septum inlets, regulated supply of nitrogen, ethylene and propylene, and equipped with disposable PEEK mechanical stirrers (800 RPM). The autoclaves were prepared by purging with dry nitrogen at 110° C. or 115° C. for 5 hours and then at 25° C. for 5 hours.

Ethylene Polymerization (PE) and Ethylene/1-octene Copolymerization (EO):

The reactor was prepared as described above, and then purged with ethylene. For MAO (Act ID=M) activated runs, toluene, 1-octene (100 μL when used), and activator (MAO) were added via syringe at room temperature and atmospheric pressure. The reactor was then brought to process temperature (80° C.) and charged with ethylene to process pressure (75 psig=618.5 kPa or 200 psig=1480.3 kPa) while stirring at 800 RPM. The pre-catalyst solution was then added via syringe to the reactor at process conditions. For dimethylanilinium tetrakisperfluorophenylborate (Act ID=D) activated runs, toluene, 1-octene (100 μL when used) and scavenger (TnOAl, 0.5 μmol) were added via syringe at room temperature and atmospheric pressure. The reactor was then brought to process temperature (80° C.) and charged with ethylene to process pressure (75 psig=618.5 kPa or 200 psig=1480.3 kPa) while stirring at 800 RPM. The activator solution, followed by the pre-catalyst solution, was injected via syringe to the reactor at process conditions. Ethylene was allowed to enter (through the use of computer controlled solenoid valves) the autoclaves during polymerization to maintain reactor gauge pressure (+/−2 psig). Reactor temperature was monitored and typically maintained within +/−1° C. Polymerizations were halted by addition of approximately 50 psi compressed air to the autoclave for approximately 30 seconds. The polymerizations were quenched after a predetermined cumulative amount of ethylene had been added (maximum quench value in psid) or for a maximum of 30 minutes polymerization time. Afterwards, the reactors were cooled and vented. Polymers were isolated after the solvent was removed in-vacuo. Yields reported include total weight of polymer and residual catalyst. Catalyst activity is reported as grams of polymer per mmol transition metal compound per hour of reaction time (g/mmol·hr). Ethylene homopolymerization and ethylene/1-octene copolymerization runs are summarized in Table 3.

### Propylene Polymerization (PP):

The reactor was prepared as described above, then heated to 40° C., and then purged with propylene gas at atmospheric pressure. For MAO activated runs, toluene or isohexane, MAO, and liquid propylene (1.0 mL) were added via syringe. The reactor was then heated to process temperature (70° C. or 100° C.) while stirring at 800 RPM. The pre-catalyst solution was added via syringe with the reactor at process conditions. For dimethylanilinium tetrakisperfluorophenylborate or dimethylanilinium n tetrakisperfluoronaphthalenylborate activated runs, toluene or isohexanes, liquid propylene (1.0 mL) and scavenger (TnOAl, 0.5 μmol) were added via syringe. The reactor was then brought to process temperature (70 or 100° C.) while stirring at 800 RPM. The activator solution, followed by the pre-catalyst solution, were injected via syringe to the reactor at process conditions. Reactor temperature was monitored and typically maintained within +/−1° C. Polymerizations were halted by addition of approximately 50 psi compressed air to the autoclaves for approximately 30 seconds. The polymerizations were quenched based on a predetermined pressure loss (maximum quench value) or for a maximum of 30 minutes. The reactors were cooled and vented. The polymers were isolated after the solvent was removed in-vacuo. The actual quench time(s) is reported as quench time(s). Yields reported include total weight of polymer and residual catalyst. Catalyst activity is reported as grams of polymer per mmol transition metal compound per hour of reaction time (g/mmol·hr). Propylene homopolymerization examples are reported in Table 1 with additional characterization in Table 2.

### Small Scale Polymer Characterization

For analytical testing, polymer sample solutions were prepared by dissolving polymer in 1,2,4-trichlorobenzene (TCB, 99+% purity from Sigma-Aldrich) containing 2,6-di-tert-butyl-4-methylphenol (BHT, 99% from Aldrich) at 165° C. in a shaker oven for approximately 3 hours. The typical concentration of polymer in solution was between 0.1 to 0.9 mg/mL with a BHT concentration of 1.25 mg BHT/mL of TCB. Samples were cooled to 135° C. for testing.

### Gel Permeation Chromotography

High temperature size exclusion chromatography was performed using an automated “Rapid GPC” system as described in U.S. Pat. Nos. 6,491,816; 6,491,823; 6,475,391; 6,461,515; 6,436,292; 6,406,632; 6,175,409; 6,454,947; 6,260,407; and 6,294,388; each of which is incorporated herein by reference. Molecular weights (weight average molecular weight (Mw) and number average molecular weight (Mn)) and molecular weight distribution (MWD=Mw/Mn), which is also sometimes referred to as the polydispersity index (PDI) of the polymer, were measured by Gel Permeation Chromatography using a Symyx Technology GPC equipped with evaporative light scattering detector (ELSD) and calibrated using polystyrene standards (Polymer Laboratories: Polystyrene Calibration Kit S-M-10: Mp (peak Mw) between 5000 and 3,390,000). Alternatively, samples were measured by Gel Permeation Chromatography using a Symyx Technology GPC equipped with dual wavelength infrared detector and calibrated using polystyrene standards (Polymer Laboratories: Polystyrene Calibration Kit S-M-10: Mp (peak Mw) between 580 and 3,039,000). Samples (250 μL of a polymer solution in TCB were injected into the system) were run at an eluent flow rate of 2.0 mL/minute (135° C. sample temperatures, 165° C. oven/columns) using three Polymer Laboratories: PLgel 10 μm Mixed-B 300×7.5 mm columns in series. No column spreading corrections were employed. Numerical analyses were performed using Epoch® software available from Symyx Technologies or Automation Studio software available from Freeslate. The molecular weights obtained are relative to linear polystyrene standards. Molecular weight data is reported in Tables 1, 2, and 3 under the headings Mn, Mw and PDI as defined above. PDI values marked with an “\hat{ }” indicate that the ELSD was used; no additional marking indicates that the dual wavelength infrared detector was used.

### Differential Scanning Calorimetry

Differential Scanning Calorimetry (DSC) measurements were performed on a TA-Q100 instrument to determine the melting point of the polymers. Samples were pre-annealed at 220° C. for 15 minutes and then allowed to cool to room temperature overnight. The samples were then heated to 220° C. at a rate of 100° C./minute and then cooled at a rate of 50° C./minute. Melting points were collected during the heating period. The results are reported in the Tables 1 and 3 under the heading, Tm (° C.).

### FTIR

Samples for infrared analysis were prepared by depositing the stabilized polymer solution onto a silanized wafer. By this method, approximately between 0.12 mg and 0.24 mg of polymer is deposited on the wafer cell. The samples were subsequently analyzed on a Brucker Equinox 55 FTIR spectrometer equipped with Pikes' MappIR specular reflectance sample accessory. Spectra, covering a spectral range of 5000 cm⁻¹ to 500 cm⁻¹, were collected at a 2 cm⁻¹ resolution with 32 scans. For ethylene-1-octene copolymers, the wt % octene in the copolymer was determined via measurement of the methyl deformation band at ˜1375 cm⁻¹. The peak height of this band was normalized by the combination and overtone band at ˜4321 cm⁻¹, which corrects for path length differences. The normalized peak height was correlated to individual calibration curves from ¹H NMR data to predict the wt % octene content within a concentration range of ˜2 to 35 wt % for octene. Typically, R² correlations of 0.98 or greater are achieved. These numbers are reported in Table 3 under the heading C₈ (wt %).

### ¹³C NMR

¹³C NMR spectroscopy was used to characterize some propylene polymer samples produced in experiments collected in Table 2. Unless otherwise indicated the polymer samples for ¹³C NMR spectroscopy were dissolved in d₂-1,1,2,2-tetrachloroethane and the samples were recorded at 125° C. using a NMR spectrometer with a ¹³C NMR frequency of 150 MHz. Polymer resonance peaks are referenced to mmmm=21.8 ppm. Calculations involved in the characterization of polymers by NMR follow the work of F. A. Bovey in “Polymer Conformation and Configuration” Academic Press, New York 1969 and J. Randall in “Polymer Sequence Determination, Carbon-13 NMR Method”, Academic Press, New York, 1977.

The stereodefects measured as “stereo defects/10,000 monomer units” are calculated from the sum of the intensities of mmrr, mmrm+rrmr, and rmrm resonance peaks times 5000. The intensities used in the calculations are normalized to the total number of monomers in the sample. Methods for measuring 2,1 regio defects/10,000 monomers and 1,3 regio defects/10,000 monomers follow standard methods. Additional references include Grassi, A. et.al. (1988) Macromolecules, v.21, pp. 617-622 and Busico et.al. (1994) Macromolecules, v.27, pp. 7538-7543. The average meso run length=10000/[(stereo defects/10000 C)+(2,1-regio defects/10000 C)+(1,3-regio-defects/10000 C)].

Polymerization results are collected in Tables 1, 2, and 3 below. “EX#” stands for example number, and those numbers having a “C-” in front of the number are comparative examples. “Cat ID” identifies the pre-catalyst used in the experiment. Corresponding letters identifying the pre-catalyst are located in the synthetic experimental section. “Cat (μmol)” is the amount of pre-catalyst added to the reactor. For all experiments using dimethylanilinium tetrakisperfluorophenylborate (Act ID=D), the molar ratio of activator/pre-catalyst was 1.1. For all experiments using MAO (Act ID=M) as the activator, a 500 Al/M molar ratio was used. T (° C.) is the polymerization temperature which was typically maintained within +/−1° C. “Yield” is polymer yield, and is not corrected for catalyst residue. “Quench time(s)” is the actual duration of the polymerization run in seconds. “Quench Value (psid)” for ethylene based polymerization runs (no propylene) is the set maximum amount of ethylene uptake (conversion) for the experiment. If a polymerization quench time is less than the maximum time set, then the polymerization was run until the set maximum value of ethylene uptake was reached. For propylene homopolymerization runs, quench value indicates the maximum set pressure loss (conversion) of propylene during the polymerization. Activity is reported at grams polymer per mmol of catalyst per hour. Pre-catalysts used in the polymerization experiments are summarized below. Catalysts B and C are comparative catalysts.

TABLE 1
Small scale propylene polymerization examples

| Cat ID = A | Cat ID = B | Cat ID = C |
|---|---|---|
| 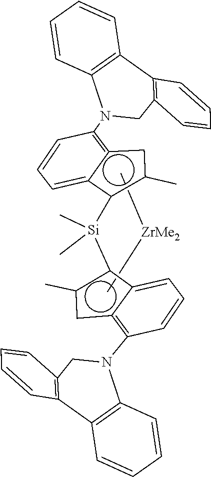 | 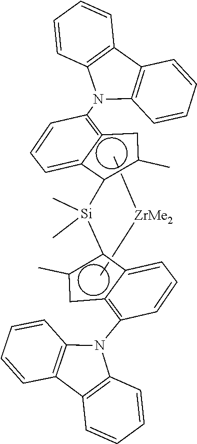 | 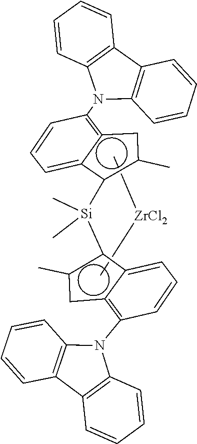 |

General reaction conditions: Total solvent volume including catalyst and activator diluents was 4.1 ml solvent; 1.0 ml propylene; pre-catalyst amount is indicated in the table and 500 equiv. Act M or 1.1 equiv. Act D was used; TnOAl (0.5 μmol) was used when Act D was used; polymerization was conducted at 70° C. or 100° C. as indicated.; Quench was set for the psi loss of 8 psid or for a maximum time of 30 minutes.

TABLE 1

| | | | | | | | | | Activity | | | | | |
|---|---|---|---|---|---|---|---|---|---|---|---|---|---|---|
| | | | | Iso- | | | quench | | (g | | | | | |
| | Cat | Act | Cat | hexane | Toluene | T | time | | P/mmol | | | | | Tm |
| Ex# | ID | ID | (μmol) | (μL) | (μL) | (° C.) | (s) | yield (g) | cat · hr) | Mn | Mw | Mz | PDI | (° C.) |
| 1 | A | M | 0.040 | 0 | 4099 | 70 | 34 | 0.2948 | 780,353 | 79,806 | 191,687 | 681,039 | 2.40 | 150.2 |
| 2 | A | M | 0.040 | 0 | 4099 | 70 | 37 | 0.3314 | 806,108 | 78,865 | 200,589 | 792,725 | 2.54 | 151.3 |
| 3 | A | M | 0.040 | 0 | 4099 | 70 | 35 | 0.3416 | 878,400 | 81,873 | 207,156 | 870,329 | 2.53 | 150.4 |
| 4 | A | M | 0.040 | 0 | 4099 | 100 | 569 | 0.5775 | 91,344 | 40,507 | 75,150 | 163,057 | 1.86 | 147.5 |
| 5 | A | M | 0.040 | 0 | 4099 | 100 | 26 | 0.2140 | 740,769 | 51,206 | 91,760 | 227,712 | 1.79 | 149.6 |
| 6 | A | M | 0.040 | 0 | 4099 | 100 | 25 | 0.2285 | 822,600 | 50,986 | 95,805 | 264,687 | 1.88 | 149.7 |
| 7 | A | D | 0.040 | 3832 | 268 | 70 | 34 | 0.3593 | 951,088 | 63,972 | 205,042 | 822,580 | 3.21 | 150.8 |
| 8 | A | D | 0.040 | 3832 | 268 | 70 | 164 | 0.2511 | 137,799 | 213,124 | 425,343 | 1,149,713 | 2.00 | 153.1 |
| 9 | A | D | 0.040 | 3832 | 268 | 70 | 38 | 0.3923 | 929,132 | 66,772 | 232,645 | 1,103,605 | 3.48 | 150.6 |
| 10 | A | D | 0.040 | 3832 | 268 | 100 | 27 | 0.2801 | 933,667 | 43,781 | 99,701 | 359,226 | 2.28 | 148.1 |
| 11 | A | D | 0.040 | 3832 | 268 | 100 | 515 | 0.0643 | 11,237 | 195,052 | 331,247 | 652,876 | 1.70 | 150.1 |
| 12 | A | D | 0.040 | 3832 | 268 | 100 | 162 | 0.1016 | 56,444 | 122,098 | 208,230 | 446,065 | 1.71 | 150.6 |
| C-1 | B | M | 0.040 | 0 | 4099 | 70 | 188 | 0.3404 | 162,957 | 298,482 | 630,605 | 1,671,736 | 2.11 | 159.6 |
| C-2 | B | M | 0.040 | 0 | 4099 | 70 | 256 | 0.4490 | 157,852 | 224,554 | 560,175 | 1,621,450 | 2.49 | 159.5 |
| C-3 | B | M | 0.040 | 0 | 4099 | 70 | 234 | 0.4033 | 155,115 | 203,125 | 534,216 | 1,609,964 | 2.63 | 158.1 |
| C-4 | B | M | 0.040 | 0 | 4099 | 100 | 123 | 0.1486 | 108,732 | 166,877 | 308,565 | 674,227 | 1.85 | 157.7 |
| C-5 | B | M | 0.040 | 0 | 4099 | 100 | 114 | 0.1373 | 108,395 | 166,844 | 307,246 | 685,825 | 1.84 | 156.3 |
| C-6 | B | M | 0.040 | 0 | 4099 | 100 | 115 | 0.1392 | 108,939 | 163,385 | 298,673 | 629,187 | 1.83 | 156.3 |
| C-7 | B | D | 0.025 | 3895 | 205 | 70 | 268 | 0.3633 | 195,206 | 251,696 | 665,814 | 2,086,521 | 2.65 | 161.7 |
| C-8 | B | D | 0.025 | 3895 | 205 | 70 | 323 | 0.2909 | 129,689 | 516,715 | 963,614 | 2,385,727 | 1.86 | 162.4 |
| C-9 | B | D | 0.025 | 3895 | 205 | 70 | 417 | 0.1074 | 37,088 | 723,734 | 1,269,304 | 2,907,247 | 1.75 | 163.6 |
| C-10 | B | D | 0.025 | 3895 | 205 | 100 | 97 | 0.1505 | 223,423 | 125,019 | 215,082 | 445,762 | 1.72 | 155.8 |
| C-11 | B | D | 0.025 | 3895 | 205 | 100 | 120 | 0.1669 | 200,280 | 105,326 | 208,174 | 489,364 | 1.98 | 155.5 |
| C-12 | B | D | 0.025 | 3895 | 205 | 100 | 254 | 0.0678 | 38,438 | 140,442 | 243,853 | 502,914 | 1.74 | 154.8 |

TABLE 2
¹³C NMR data for select polypropylene examples

| | | | | | | | | | | | | | 2,1-regio | | |
|---|---|---|---|---|---|---|---|---|---|---|---|---|---|---|---|
| | | | | | | | | | | | | stereo | (ee) | 1,3 regio | |
| | | | | | | | | | | | | defects/ | defects/ | defects/ | ave, |
| | | | | | | | mmrm + | | | | | 10000 | 10000 | 10000 | meso |
| Ex# | m | r | mmmm | mmmr | rmmr | mmrr | rmrr | rmrm | rrrr | mrrr | mrrm | monomer | monomer* | monomer | length |
| 3 | 0.995 | 0.005 | 0.985 | 0.003 | 0.004 | 0.004 | 0.001 | 0.001 | 0.000 | 0.000 | 0.001 | 34.3 | 61.1 | 20.4 | 86 |
| 5 | 0.994 | 0.006 | 0.983 | 0.004 | 0.002 | 0.005 | 0.003 | 0.001 | 0.000 | 0.000 | 0.001 | 43.6 | 51.7 | 35.7 | 76 |
| 8 | 0.994 | 0.006 | 0.981 | 0.004 | 0.005 | 0.003 | 0.003 | 0.002 | 0.000 | 0.000 | 0.001 | 42.7 | 48.4 | 7.2 | 102 |
| 10 | 0.987 | 0.013 | 0.962 | 0.009 | 0.007 | 0.007 | 0.007 | 0.004 | 0.001 | 0.000 | 0.003 | 84.5 | 30.4 | 52.0 | 60 |
| C-1 | 0.995 | 0.005 | 0.985 | 0.003 | 0.003 | 0.004 | 0.002 | 0.001 | 0.000 | 0.000 | 0.002 | 32.7 | 21.6 | 7.1 | 163 |
| C-4 | 0.993 | 0.007 | 0.977 | 0.005 | 0.005 | 0.005 | 0.003 | 0.001 | 0.000 | 0.000 | 0.002 | 47.7 | 17.7 | 12.4 | 129 |
| C-8 | 0.994 | 0.006 | 0.988 | 0.003 | 0.000 | 0.003 | 0.003 | 0.001 | 0.000 | 0.001 | 0.001 | 35.6 | 16.0 | 4.8 | 177 |
| C-11 | 0.992 | 0.008 | 0.973 | 0.010 | 0.005 | 0.007 | 0.002 | 0.001 | 0.000 | 0.000 | 0.003 | 47.8 | 13.9 | 13.3 | 133 |

*no 2,1-regio (te) or 2,1-regio (et) were observed.

### Small Scale Ethylene Homopolymerizations and Ethylene-1-Octene Copolymerization Examples (As Shown in Table 3)

General reaction conditions for Ethylene homopolymerizations: Total solvent volume including catalyst and activator diluents was 5.0 ml toluene; 0.025 μmol pre-catalyst and 500 equiv. Act M or 1.1 equiv. Act D; 80° C. polymerization temperature; 75 psi of ethylene with uptake; Quench Value was set at 20 psid ethylene uptake or for a maximum time of 30 minutes.

General reaction conditions for Ethylene-1-octene copolymerizations: Total solvent volume including catalyst and activator diluents was 4.9 ml toluene; 0.1 ml 1-octene; 0.020 or 0.025 μmol pre-catalyst and 500 equiv. Act M or 1.1 equiv. Act D; 80° C. polymerization temperature; 75 or 200 psi of ethylene with uptake; Quench Value was set at 20 psid ethylene uptake when 75 psi of ethylene was used and for 15 psid ethylene uptake when 200 psi of ethylene was used, or for a maximum time of 30 minutes.

TABLE 3

| | | | | | | | | | Activity | | | | | | |
|---|---|---|---|---|---|---|---|---|---|---|---|---|---|---|---|
| | | | | | | | quench | | (g | | | | | | |
| | Cat | Act | Cat | Toluene | octene | C2 | time | yield | P/mmol | | | | | C8 | Tm |
| Ex# | ID | ID | (μmol) | (μL) | (μL) | (psig) | (s) | (g) | cat · hr) | Mn | Mw | Mz | PDI | (wt %) | (° C.) |
| 13 | A | D | 0.025 | 5000 | 0 | 75 | 278 | 0.0904 | 46,826 | 632,302 | 1,324,335 | 3,331,023 | 2.09 | | 132.8 |
| 14 | A | D | 0.025 | 5000 | 0 | 75 | 245 | 0.0838 | 49,254 | 626,957 | 1,125,485 | 2,205,652 | 1.80 | | 133.1 |
| 15 | A | D | 0.025 | 5000 | 0 | 75 | 253 | 0.0896 | 50,998 | 622,876 | 1,137,410 | 2,314,263 | 1.83 | | 132.6 |
| 16 | A | D | 0.025 | 4900 | 100 | 75 | 193 | 0.0486 | 36,261 | 188,487 | 322,531 | 676,699 | 1.71 | 31.0 | 79.6 |
| 17 | A | D | 0.025 | 4900 | 100 | 75 | 172 | 0.0488 | 40,856 | 189,165 | 322,062 | 629,631 | 1.70 | 27.9 | 80.2 |
| 18 | A | D | 0.025 | 4900 | 100 | 75 | 179 | 0.0476 | 38,293 | 207,360 | 339,018 | 742,667 | 1.63 | 27.1 | 80.1 |
| 19 | A | D | 0.025 | 4900 | 100 | 200 | 47 | 0.0990 | 303,319 | 280,307 | 466,419 | 917,178 | 1.66 | 12.6 | 101.7 |
| 20 | A | D | 0.025 | 4900 | 100 | 200 | 52 | 0.1121 | 310,431 | 243,802 | 438,424 | 894,605 | 1.80 | 12.2 | 101.7 |
| 21 | A | D | 0.025 | 4900 | 100 | 200 | 47 | 0.1007 | 308,528 | 258,324 | 446,842 | 909,044 | 1.73 | 13.1 | 102.0 |
| 22 | A | M | 0.025 | 4999 | 0 | 75 | 130 | 0.0918 | 101,686 | 805,734 | 1,791,773 | 4,831,613 | 2.22 | | 133.3 |
| 23 | A | M | 0.025 | 4999 | 0 | 75 | 154 | 0.0921 | 86,119 | 575,380 | 1,158,522 | 2,864,184 | 2.01 | | 132.2 |
| 24 | A | M | 0.025 | 4899 | 100 | 75 | 206 | 0.0642 | 44,878 | 175,737 | 271,047 | 518,414 | 1.54 | 28.3 | 70.8 |
| 25 | A | M | 0.025 | 4899 | 100 | 75 | 200 | 0.0624 | 44,928 | 153,200 | 276,155 | 644,031 | 1.80 | 24.7 | 72.3 |
| 26 | A | M | 0.025 | 4899 | 100 | 75 | 198 | 0.0652 | 47,418 | 153,260 | 269,387 | 564,781 | 1.76 | 26.3 | 75.5 |
| 27 | A | M | 0.025 | 4899 | 100 | 200 | 101 | 0.1642 | 234,107 | 176,231 | 376,504 | 952,859 | 2.14 | 12.6 | 100.4 |
| 28 | A | M | 0.025 | 4899 | 100 | 200 | 91 | 0.1569 | 248,281 | 176,891 | 355,206 | 852,647 | 2.01 | 20.3 | 97.8 |
| 29 | A | M | 0.025 | 4899 | 100 | 200 | 102 | 0.1612 | 227,576 | 176,545 | 356,227 | 795,062 | 2.02 | 14.6 | 101.4 |
| C-13 | C | M | 0.020 | 4900 | 100 | 75 | 233 | 0.0544 | 41,990 | 100,801 | 148,262 | | 1.47\hat{ } | 29.8 | |
| C-14 | C | M | 0.020 | 4900 | 100 | 75 | 184 | 0.0569 | 55,542 | 101,880 | 150,185 | | 1.47\hat{ } | 28.0 | |
| C-15 | C | M | 0.020 | 4900 | 100 | 75 | 229 | 0.0504 | 39,702 | 104,329 | 153,032 | | 1.47\hat{ } | 26.9 | |

PDI values marked with an “\hat{ }” indicate that the evaporative light scattering detector was used.

Preparation of silica supported MAO (SMAO): In a Celstir® flask, 10.0 g of PD14024 silica (PQ, dehydrated at 200° C.) was suspended in 100 mL of dry toluene and cooled in the freezer to −20° C. While stirring, 22.0 g of 30% solution of MAO was slowly added to the stirring silica mixture (over 10 minutes). The reaction mixture was allowed to stir for 1.5 hours. After 1.5 hours, the temperature was raised to 100° C. and the reaction was allowed to stir for additional 3 hours. Upon cooling, the resulting slurry was filtered, and the solids were washed with toluene (2×50 mL), pentane (2×50 mL) and were dried in vacuo for at least 2 hours to give resulting SMAO as a white free flowing powder.

Preparation of supported catalyst A (s-A): 0.505 g of SMAO was slurried in 5 mL of toluene and placed on a vortexer. TIBAL (0.178 mL of IM solution in hexane) was then added, and the mixture was vortexed for 15 minutes at room temperature. After 15 minutes, a solution of metallocene A (13.5 mg in 3 mL of toluene) was added dropwise to the vortexing mixture of SMAO. The slurry was vortexed for 2.5 hours, the mixture was then filtered, washed with toluene (2×5 mL) and pentane (2×5 mL) and dried in vacuo to afford supported catalysts as a dark green free flowing solid. The solid was suspended in mineral oil to make 5 wt % slurry prior to reactor testing.

### Differential Scanning Calorimetry (DSC-2):

Peak melting point, Tₘ, described for larger scale reactor batches (also referred to as melting point) and peak crystallization temperature, T_{c}, (also referred to as crystallization temperature) are determined using the following DSC procedure. Differential scanning calorimetric (DSC-2) data can be obtained using a TA Instruments model DSC2500 machine. Samples weighing approximately 5 mg to 10 mg are sealed in an aluminum hermetic sample pan and loaded into the instrument at about room temperature. The DSC data are recorded by first gradually heating the sample to 220° C. at a rate of 10° C./minute in order to erase all thermal history. The sample is kept at 220° C. for 5 minutes, then cooled to −10° C. at a rate of 10° C./minute, followed by an isothermal for 5 minutes and heating to 220° C. at 10° C./minute, holding at 220° C. for 5 minutes and then cooling down to 25° C. at a rate of 10° C./minute. Both the first and second cycle thermal events were recorded. The melting and crystallization temperatures reported here were obtained during the second heating/cooling cycle unless otherwise noted.

### Larger Scale Supported Catalyst Polymerization Examples Using Supported Catalysts

Preparation of homopolypropylenes. A 1L autoclave reactor equipped with a mechanical stirrer was used for polymer preparation. Prior to the run, the reactor was placed under nitrogen purge while maintaining 90° C. temperature for 30 minutes. Upon cooling back to ambient temperature, propylene feed (500 mL), scavenger (0.2 mL of 1M TIBAL, triisobutylaluminum) and desired amount of hydrogen (charged from a 50 mL bomb) were introduced to the reactor and were allowed to mix for 5 minutes. Desired amount of supported catalyst (typically 12.5 mg-25.0 mg) was then introduced to the reactor by flushing the pre-determined amount of catalyst slurry (5 wt % in mineral oil) from a catalyst tube with 100 mL of liquid propylene. The reactor was kept for 5 minutes at room temperature (pre-polymerization stage), before raising the temperature to 70° C. The reaction was allowed to proceed at that temperature for a desired time period (typically 30 minutes). After the given time, the temperature was reduced to 25° C., the excess propylene was vented off and the polymer granules were collected, and dried under vacuum at 60° C. overnight. Data is collected in Table 4. Catalyst productivity has units of grams polymer per gram catalyst per hour.

Preparation of propylene/ethylene random copolymers. A 1L autoclave reactor equipped with a mechanical stirrer was used for polymer preparation. Prior to the run, the reactor was placed under nitrogen purge while maintaining 90° C. temperature for 30 minutes. Upon cooling back to ambient temperature, propylene feed (500 mL), and scavenger (0.2 mL of 1M TIBAL, triisobutylaluminum) were introduced to the reactor and were allowed to mix for 5 minutes. Desired amount of supported catalyst (typically 12.5 mg-25.0 mg) was then introduced to the reactor by flushing the pre-determined amount of catalyst slurry (5 wt % in mineral oil) from a catalyst tube with 100 mL of liquid propylene. The reactor was kept for 10 minutes at room temperature (pre-poly stage). Temperature was then raised to 70° C., and desired amount of ethylene was introduced. The reactor pressure was kept at steady state by balancing with ethylene. The reaction was allowed to proceed at that temperature for a desired time period (typically 15-30 minutes). After the given time, the temperature was reduced to 25° C., the excess propylene was vented off and the polymer granules were collected, and dried under vacuum at 60° C. overnight.

TABLE 4
Larger scale slurry polymerization of propylene examples using supported catalyst
A (s-A). Molecular weights are determined by GPC-4D and Tₘ by DSC-2 method above.

| | Cat | | | | Cat | | | | | |
|---|---|---|---|---|---|---|---|---|---|---|
| | s-A | H₂ | C₂ | Yield | productivity | Mₙ | M_{w} | M_{z} | | Tₘ |
| Ex | (mg) | (mmol) | (psi) | (g) | (g/g•h) | (g/mol) | (g/mol) | (g/mol) | PDI | (° C.) |
| s-1 | 25.1 | 0 | 0 | 4.4 | 352 | 186,829 | 836,327 | 1,964,000 | 4.48 | 145.0 |
| s-2 | 25.2 | 2 | 0 | 62.4 | 4,931 | 21,775 | 140,035 | 411,373 | 6.43 | 144.6 |
| s-3 | 25.1 | 0 | 7 | 8.0 | 642 | 151,791 | 689,710 | 1,538,117 | 4.54 | 141.4 |
| s-4 | 25.6 | 0 | 20 | 18.4 | 1439 | 169,160 | 641,955 | 1,372,663 | 3.79 | 135.6 |
| s-5 | 24.6 | 1 | 20 | 42.8 | 3,481 | 28,100 | 164,752 | 439,895 | 5.86 | 140.5 |
| s-6 | 24.7 | 2 | 20 | 51.5 | 4,173 | 27,421 | 162,000 | 453,575 | 5.91 | 139.7 |

Overall, metallocene catalyst compounds (such as ansa-metallocene catalyst compounds) of the present disclosure provide improved catalysts, catalyst systems, polymerization methods, and polymers. It has been discovered that ansa-metallocene catalyst compounds having a phenanthridinyl moiety at the 4-position of an indenyl ligand can provide isotactic polypropylenes and ethylene copolymers at high activities. The isotactic polypropylenes and ethylene copolymers formed using catalyst compounds of the present disclosure can have a high molecular weight. It has also been discovered that ansa-metallocene catalyst compounds can be disposed on a support (such as silica) to provide a supported catalyst compound. Supported catalyst compounds of the present disclosure have been found to provide reduced fracturing as compared to conventional supported catalyst compounds used for polypropylene production. Further, supported catalyst compounds of the present disclosure can have a reduced propensity to fracture and can provide consistent polymer properties, such as properties of isotactic polypropylene. In addition, isotactic polypropylenes formed using supported catalyst compounds of the present disclosure can have a high molecular weight, useful processability (e.g., low melting point and broad polydispersity), and/or can be capable of forming products such as films having low haze (e.g., due to the low melting point).

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the present disclosure, additionally, they do not exclude impurities and variances normally associated with the elements and materials used.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All documents described herein are incorporated by reference herein, including any priority documents and or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including” for purposes of United States law. Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

While the present disclosure has been described with respect to a number of embodiments and examples, those skilled in the art, having benefit of this disclosure, will appreciate that other embodiments can be devised which do not depart from the scope and spirit of the present disclosure.

We claim:

1. A catalyst compound represented by Formula (I):
T_{y}LAMXₙ₋₂ (I)
wherein:
M is a group 3-6 metal;
n is the oxidation state of M;
A is a substituted monocyclic or polycyclic arenyl ligand bonded to M and is substituted by at least one phenanthridin-5-yl substituent;
L is a substituted or unsubstituted monocyclic or polycyclic arenyl ligand bonded to M, and optionally, may be the same as A;
T is a bridging group and when present is bonded to A and L;
y is 1 or 0 indicating the presence or absence of T; and
each X is independently a univalent anionic ligand, or two Xs are joined and bound to M to form a metallocycle ring, or two Xs are joined to form a chelating ligand, a diene ligand, or an alkylidene ligand.

2. The catalyst compound of claim 1, wherein the at least one phenanthridin-5-yl substituent of Formula (I) is represented by Formula (Ia): 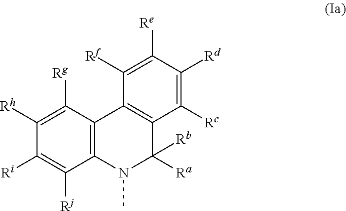
wherein:
each of R^{a}, R^{b}, R^{c}, R^{d}, R^{e}, R^{f}, R^{g}, R^{h}, Rⁱ, and R^{j} is independently selected from the group consisting of hydrogen, a hydrocarbyl, a heteroatom or a heteroatom-containing group, or any adjacent R^{c}, R^{d}, R^{e}, R^{f}, R^{g}, R^{h}, Rⁱ, and R^{j} are joined to form one or more hydrocarbyl rings or heterocyclic rings each having 5, 6, 7, or 8 ring atoms; and
the dashed line of Formula (Ia) indicates a bond to the monocyclic arenyl or polycyclic arenyl ligand of A, and optionally L, of Formula (I).

3. The catalyst compound of claim 2, wherein A of Formula (I) is selected from the group consisting of substituted cyclopentadienyl, indenyl, fluorenyl, cyclopenta[b]naphthalenyl, cyclopenta[a]naphthalenyl, tetrahydro-s-indacenyl, and tetrahydro-as-indacenyl.

4. The catalyst compound of claim 2, wherein L of Formula (I) is selected from the group consisting of substituted or unsubstituted cyclopentadienyl, indenyl, fluorenyl, cyclopenta[b]naphthalenyl, cyclopenta[a]naphthalenyl, tetrahydro-s-indacenyl, and tetrahydro-as-indacenyl.

5. The catalyst compound of claim 3, wherein the phenanthridin-5-yl substituent is on the 4-position of A, and optionally on the 4-position of L, of Formula (I). 6 The catalyst compound of claim 1 wherein M is group 4 metal.

7. The catalyst compound of claim 1, wherein the catalyst compound of Formula (I) is represented by Formula (III): 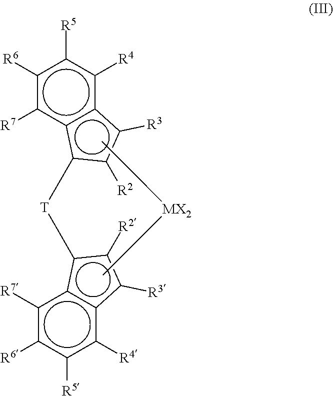
wherein:
M is Zr or Hf;
each of R², R³, R⁵, R⁶, R⁷, R^{2′}, R^{3′}, R^{5′}, R^{6′}, and R^{7′} is independently selected from the group consisting of hydrogen, a hydrocarbyl, a heteroatom, and a heteroatom-containing group, or one or more of R² and R³, R⁵ and R⁶, R⁶ and R⁷, R^{2′} and R^{3′}, R^{5′} and R^{6′}, and R^{6′} and R^{7′} are joined to form one or more saturated, partially saturated, or aromatic rings;
T is represented by formula R⁸₂J or (R⁸)₄J₂ wherein J is selected from the group consisting of C, Si, and Ge, wherein each instance of R⁸ is independently selected from the group consisting of hydrogen, halide, and a C₁ to C₄₀ hydrocarbyl, or two instances of R⁸ are joined to form a cyclic structure including a saturated ring system, a partially saturated ring system, an aromatic ring system, or a fused ring system;
each X is independently selected from the group consisting of halide, hydrocarbyl, hydride, amide, alkoxide, sulfide, and phosphide, or two instances of X are joined together to form a metallocycle ring, or two instances of X are joined to form a chelating ligand, a diene ligand, or an alkylidene ligand; and
each of R⁴ and R^{4′} is independently represented by Formula (IIIa): 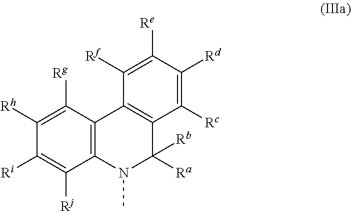
wherein:
each instance of R^{a}, R^{b}, R^{c}, R^{d}, R^{e}, R^{f}, R^{g}, R^{h}, Rⁱ, and R^{j} is independently selected from the group consisting of hydrogen, hydrocarbyl, a heteroatom, and a heteroatom-containing group, or any adjacent R^{c}, R^{d}, R^{e}, R^{f}, R^{g}, R^{h}, Rⁱ, and R^{j} is joined to form one or more hydrocarbyl rings or heterocyclic rings each having 5, 6, 7, or 8 ring atoms; and
the dashed line indicates the bond to the 4-position of an indenyl ligand shown in Formula (III).

8. The catalyst compound of claim 7, wherein each of R², R³, R⁵, R⁶, R⁷, R^{2′}, R^{3′}, R^{5′}, R^{6′}, and R^{7′} of Formula (III) is independently selected from the group consisting of hydrogen, a hydrocarbyl, a silylcarbyl, an alkoxyl, a halide, or a siloxyl.

9. The catalyst compound of claim 8, wherein each of R², R³, R⁵, R⁶, R^{7,} R^{2′}, R^{3′}, R^{5′}, R^{6′}, and R^{7′} of Formula (III) is independently selected from the group consisting of hydrogen and a C₁-C₁₀ alkyl.

10. The catalyst compound of claim 7, wherein each instance of X of Formula (III) is independently selected from the group consisting of chloro and methyl.

11. The catalyst compound of claim 7, wherein T of Formula (III) is selected from the group consisting of CH₂, CH₂CH₂, C(CH₃)₂, CPh₂, SiMe₂, SiPh₂, SiMePh, Si(CH₂)₃, Si(CH₂)₄, and Si(CH₂)₅.

12. The catalyst compound of claim 7, wherein each of R² and R^{2′} of Formula (III) is independently C₁-C₁₀ alkyl.

13. The catalyst compound of claim 12, wherein each of R² and R^{2′} of Formula (III) is methyl.

14. The catalyst compound of claim 7, wherein each of R³, R⁷, R^{3′}, and R^{7′} is hydrogen.

15. The catalyst compound of claim 7, wherein each instance of R^{a}, R^{b}, R^{c}, R^{d}, R^{e}, R^{f}, R^{g}, R^{h}, Rⁱ, and R^{j} of Formula (III) and Formula (IIIa) is independently selected from the group consisting of hydrogen and C₁-C₁₀ alkyl.

16. The catalyst compound of claim 7, wherein R⁴ and R^{4′} of Formula (III) and Formula (IIIa) are independently selected from the group consisting of:
phenanthridin-5(6H)-yl,
4-methyl-phenanthridin-5(6H)-yl,
6-methyl-phenanthridin-5(6H)-yl,
1,10-dimethyl-phenanthridin-5(6H)-yl,
2,9-dimethyl-phenanthridin-5(6H)-yl,
3,4-dimethyl-phenanthridin-5(6H)-yl,
2,4-dimethyl-phenanthridin-5(6H)-yl,
6,6-dimethyl-phenanthridin-5(6H)-yl,
6,8-dimethyl-phenanthridin-5(6H)-yl,
3,6,6,9-tetramethyl-phenanthridin-5(6H)-yl,
3,6,8,9-tetramethyl-phenanthridin-5(6H)-yl,
6-isopropyl-phenanthridin-5(6H)-yl,
4-ethyl-phenanthridin-5(6H)-yl,
6-ethyl-phenanthridin-5(6H)-yl,
benzo[k]phenanthridin-5(6H)-yl,
benzo[j]phenanthridin-5(6H)-yl,
benzo[b]phenanthridin-5(6H)-yl,
benzo[a]phenanthridin-5(6H)-yl,
2-chloro-phenanthridin-5(6H)-yl,
3-chloro-phenanthridin-5(6H)-yl,
4-chloro-5,6-phenanthridin-5(6H)-yl,
1-bromo-phenanthridin-5(6H)-yl,
2-bromo-phenanthridin-5(6H)-yl,
2-fluoro-phenanthridin-5(6H)-yl,
8-fluoro-6-methyl-phenanthridin-5(6H)-yl, and
2-bromo-6,6-dimethylphenanthridin-5(6H)-yl.

17. The catalyst compound of claim 7, wherein the catalyst compound is selected from the group consisting of:
rac-dimethylsilanediyl-bis[η⁵-2-methyl-4-(phenanthridin-5(6H)yl)inden-1-yl]zirconium dichloride,
rac-dimethylsilanediyl-bis[η⁵-2-methyl-4-(phenanthridin-5(6H)yl)inden-1-yl]zirconium dimethyl,
rac-dimethylsilanediyl-bis[η⁵-2-methyl-4-(phenanthridin-5(6H)yl)inden-1-yl]hafnium dichloride,
rac-dimethylsilanediyl-bis[η⁵-2-methyl-4-(phenanthridin-5(6H)yl)inden-1-yl]hafnium dimethyl,
rac-dimethylsilanediyl-bis[η⁵-4-(phenanthridin-5(6H)yl)inden-1-yl]zirconium dichloride,
rac-dimethylsilanediyl-bis[η⁵-4-(phenanthridin-5(6H)yl)inden-1-yl]zirconium dimethyl,
rac-dimethylsilanediyl-bis[η⁵-4-(phenanthridin-5(6H)yl)inden-1-yl]hafnium dichloride,
rac-dimethylsilanediyl-bis[η⁵-4-(phenanthridin-5(6H)yl)inden-1-yl]hafnium dimethyl,
rac-dimethylsilanediyl-bis[η⁵-6-tert-butyl-5-methoxy-2-methyl-4-(phenanthridin-5(6H)yl)inden-1-yl]zirconium dichloride,
rac-dimethylsilanediyl-bis[η⁵-6-tert-butyl-5-methoxy-2-methyl-4-(phenanthridin-5(6H)yl)inden-1-yl]hafnium dichloride,
rac-dimethylsilanediyl-bis[η⁵-6-tert-butyl-5-methoxy-2-methyl-4-(phenanthridin-5(6H)yl)inden-1-yl]zirconium dimethyl,
rac-dimethylsilanediyl-bis[η⁵-6-tert-butyl-5-methoxy-2-methyl-4-(phenanthridin-5(6H)yl)inden-1-yl]hafnium dimethyl,
rac-dimethylsilylene-bis(η⁵-2,6,6-trimethyl-4-(phenanthridin-5(6H)yl)-1,5,6,7-tetrahydro-s-indacen-1-yl)zirconium dichloride,
rac-dimethylsilylene-bis(η⁵-2,6,6-trimethyl-4-(phenanthridin-5(6H)yl)-1,5,6,7-tetrahydro-s-indacen-1-yl)hafnium dichloride,
rac-dimethylsilylene-bis(η⁵-2,6,6-trimethyl-4-(phenanthridin-5(6H)yl)-1,5,6,7-tetrahydro-s-indacen-1-yl)zirconium dimethyl,
rac-dimethylsilylene-bis(η⁵-2,6,6-trimethyl-4-(phenanthridin-5(6H)yl)-1,5,6,7-tetrahydro-s-indacen-1-yl)hafnium dimethyl,
rac-dimethylsilylene-bis(η5-2-methyl-4-(phenanthridin-5(6H)yl)-1,5,6,7-tetrahydro-s-indacen-1-yl)zirconium dichloride,
rac-dimethylsilylene-bis(η⁵-2-methyl-4-(phenanthridin-5(6H)yl)-1,5,6,7-tetrahydro-s-indacen-1-yl)hafnium dichloride,
rac-dimethylsilylene-bis(η⁵-2-methyl-4-(phenanthridin-5(6H)yl)-1,5,6,7-tetrahydro-s-indacen-1-yl)zirconium dimethyl, and
rac-dimethylsilylene-bis(η⁵-2-methyl-4-(phenanthridin-5(6H)yl)-1,5,6,7-tetrahydro-s-indacen-1-yl)hafnium dimethyl.

18. A catalyst system comprising an activator and the catalyst compound of claim 1.

19. The catalyst system of claim 18, further comprising a support material.

20. The catalyst system of claim 19, wherein the support material is selected from the group consisting of Al₂O₃, ZrO₂, SiO₂, SiO₂/Al₂O₃, SiO₂/TiO₂, silica clay, silicon oxide/clay, and mixtures thereof.

21. The catalyst system of claim 18, wherein the activator comprises a non-coordinating anion activator.

22. The catalyst system of claim 18, wherein the activator comprises an alkylalumoxane.

23. A process for producing an ethylene alpha-olefin copolymer, the process comprising:
polymerizing ethylene and at least one C₃-C₂₀ alpha-olefin by introducing the ethylene and the at least one C₃-C₂₀ alpha-olefin with a catalyst system of claim 18, in one or more continuous stirred tank reactors or loop reactors, in series or in parallel, at a reactor pressure of 0.05 MPa to 1,500 MPa and a reactor temperature of 30° C. to 230° C. to form the ethylene alpha-olefin copolymer.

24. The process of claim 23, wherein the ethylene alpha-olefin copolymer has:
a comonomer content of C₃-C₂₀ alpha-olefin units of about 10 wt % to about 35 wt %, and
a weight average molecular weight (Mw) of about 100,000 g/mol to about 2,500,000 g/mol.

25. A process for producing a propylene homopolymer or a propylene copolymer, the process comprising:
polymerizing propylene and optionally a comonomer selected from the group consisting of C₂, C₄-C₂₀ alpha-olefin, and combinations thereof by introducing the propylene and the optional comonomer with a catalyst system of claim 18, in one or more continuous stirred tank reactors or loop reactors, in series or in parallel, at a reactor pressure of 0.05 MPa to 1,500 MPa and a reactor temperature of 30° C. to 230° C. to form the propylene homopolymer or the propylene copolymer.

26. The process of claim 23, wherein the catalyst system has a catalyst activity about 50,000 gPmmolcat⁻¹hr⁻¹ to about 1,500,000 gPmmolcat⁻¹hr⁻¹.

27. The process of claim 25, wherein the process produces the propylene homopolymer or the propylene copolymer has:
a weight average molecular weight (Mw) of about 50,000 g/mol to about 2,000,000 g/mol,
a polydispersity index (PDI) value of about 1.5 to about 8, and
a melt temperature (Tm) of about 135° C. to about 165° C.

28. The process of claim 25, wherein the process produces the propylene homopolymer and the propylene homopolymer has:
a meso dyad content of about 95% to about 99.95%,
an [mmmm] pentad content of about 95.0% to about 99.5%,
less than 100 total regio defects per 10,000 propylene units, and
an average meso run length of greater than 50.
